(19) United States
(12) Patent Application Publication
(10) Pub. No.: US 2023/0315618 A1
(43) Pub. Date: Oct. 5, 2023

(54) DATA PROCESSING METHOD AND DEVICE, COMPUTING DEVICE, AND TEST REDUCTION DEVICE

(71) Applicant: ALIBABA GROUP HOLDING LIMITED, George Town (KY)

(72) Inventor: Mengyuan ZHANG, Hangzhou (CN)

(21) Appl. No.: 18/329,717

(22) Filed: Jun. 6, 2023

Related U.S. Application Data
(63) Continuation of application No. PCT/CN2021/141953, filed on Dec. 28, 2021.

(30) Foreign Application Priority Data
Dec. 29, 2020 (CN) 202011591254.7

(51) Int. Cl. G06F 11/36

(52) U.S. Cl. CPC G06F 11/3688; G06F 11/3692

(57) ABSTRACT

A data processing method includes: determining a target function corresponding to a parameter optimization request in response to the parameter optimization request; in a process of performing a parameter test on any candidate parameter by the target function, determining whether the parameter test meets a reduction condition to obtain a determination result of the candidate parameter; in response to the determination result being that the parameter test meets the reduction condition, stopping the parameter test of the candidate parameter; or in response to the determination result being that the parameter test fails to meet the reduction condition, continuing to execute the parameter test of the candidate parameter to obtain a test result of the candidate parameter.

### CROSS-REFERENCE TO RELATED APPLICATIONS

The present application claims priority to International Application No. PCT/CN2021/141953, filed Dec. 28, 2021, which claims priority to and the benefits of Chinese Patent Application No. 202011591254.7, filed on Dec. 29, 2020, both of which are incorporated herein by reference in their entireties.

### TECHNICAL FIELD

The present disclosure relates to the field of computer technology, and in particular to a data processing method and device, a computing device, and a test reduction device.

### BACKGROUND

In model computing processes of machine learning models, neural network models, etc., many parameters, such as hyperparameters composed of parameters including iteration number and network depth, and node parameters set for each computing node in a neural network model training process, need to be involved. In order to obtain more accurate computing results, it may often be necessary to set the parameters of the model to an optimal set of parameters. A common parameter optimization method may mainly include a black box optimization algorithm and a white box optimization algorithm.

In conventional systems, a target function in the black box optimization algorithm has a “black box” characteristic, and a mathematical expression form of the target function is unknown and has high complexity. When parameters are optimized by using the black box optimization algorithm, a series of candidate parameters are generated, and the target function is used to respectively perform parameter tests on a plurality of candidate parameters to obtain the test results respectively corresponding to the plurality of candidate parameters. Then, the target parameter with the optimum test result is selected from the plurality of candidate parameters according to the test results.

It can be seen from the above description that according to the existing parameter optimization method, parameter tests are respectively performed on a plurality of candidate parameters to obtain test results of all candidate parameters, and the parameter test process is complicated, resulting in a low parameter optimization efficiency.

### SUMMARY

Embodiments of the present disclosure provide a data processing method. The data processing method includes: determining a target function corresponding to a parameter optimization request in response to the parameter optimization request; in a process of performing a parameter test on any candidate parameter by the target function, obtaining a determination result of the candidate parameter determining whether the parameter test meets a reduction condition; in response to the determination result being that the parameter test meets the reduction condition, stopping the parameter test of the candidate parameter; or in response to the determination result being that the parameter test fails to meet the reduction condition, continuing to execute the parameter test of the candidate parameter to obtain a test result of the candidate parameter.

Embodiments of the present disclosure provide a data processing method. The data processing method includes: determining a processing resource corresponding to a parameter processing interface in response to a request of calling the parameter processing interface; executing using the processing resource corresponding to the parameter processing interface: determining a target function corresponding to a parameter optimization request in response to the parameter optimization request; in a process of performing a parameter test on any candidate parameter by the target function, obtaining a determination result determining whether the parameter test meets a reduction condition; in response to the determination result being that the parameter test meets the reduction condition, stopping the parameter test of the candidate parameter; or in response to the determination result being that the parameter test fails to meet the reduction condition, continuing to execute the parameter test of the candidate parameter to obtain the test result of the candidate parameter.

Embodiments of the present disclosure provide a data processing method. The data processing method includes: receiving a determination request for determining whether a parameter test on a candidate parameter by a target function meets a reduction condition initiated by a computing device, wherein the target function is determined by the computing device in response to a parameter optimization request; and determining whether the parameter test meets the reduction condition in response to the determination request. The parameter test of the candidate parameter is stopped when the reduction condition is met, and the parameter test of the candidate parameter continues to be executed when the reduction condition fails to be met so as to obtain a test result of the candidate parameter.

Embodiments of the present disclosure provide a computing device. The computing device includes: a memory configured to store one or more computer instructions; and one or more processors configured to run the one or more computer instructions stored in the memory, to execute operations of the above methods.

Embodiments of the present disclosure provide a non-transitory computer-readable storage medium. The non-transitory computer-readable storage medium stores a set of computer instructions that are executable by one or more processors of a device to cause the device to perform the above methods.

### BRIEF DESCRIPTION OF THE DRAWINGS

In order to describe the technical solution of embodiments of the present disclosure or in the conventional systems more clearly, drawings to be used in embodiments and the conventional systems are briefly introduced. Obviously, drawings described hereafter are only some embodiments of the present disclosure. For a person of ordinary skill in the art, other drawings can also be obtained according to these drawings without any inventive efforts.

FIG. 1 is a flowchart of an example data processing method according to some embodiments of the present disclosure.

FIG. 2 is a flowchart of an example data processing method according to some other embodiments of the present disclosure.

FIG. 3 is a flowchart of an example data processing method according to some other embodiments of the present disclosure.

FIG. 4 is a flowchart of an example data processing method according to some other embodiments of the present disclosure.

FIG. 5 is a flowchart of an example data processing method according to some other embodiments of the present disclosure.

FIG. 6 is a flowchart of an example data processing method according to some other embodiments of the present disclosure.

FIG. 7 is a flowchart of an example data processing method according to some other embodiments of the present disclosure.

FIG. 8 is a schematic diagram of an example data processing method according to some embodiments of the present disclosure.

FIG. 9 is a schematic structural diagram of an example data processing device according to some embodiments of the present disclosure.

FIG. 10 is a schematic structural diagram of an example computing device according to some embodiments of the present disclosure.

FIG. 11 is a schematic structural diagram of an example data processing device according to some embodiments of the present disclosure.

FIG. 12 is a schematic structural diagram of an example test reduction equipment according to some embodiments of the present disclosure.

FIG. 13 is a schematic structural diagram of an example data processing system according to some embodiments of the present disclosure.

### DETAILED DESCRIPTION

In order to describe the purpose, the technical solution and the advantages of embodiments of the present disclosure more clearly, the technical solution of embodiments of the present disclosure will be clearly and completely described hereinafter with reference to the accompanying drawings in the embodiments of the present disclosure. It is clear that, the described embodiments are only a few, but not all, embodiments of the present disclosure. Based on the embodiments of the present disclosure, all other embodiments obtained by a person of ordinary skill in the art without making an inventive effort are within the protection scope of the present disclosure.

Terms used in the embodiments of the present disclosure are for the purpose of describing specific embodiments only, and are not intended to limit the present disclosure. The singular forms “a”, “said” and “the” used in the embodiments of the present disclosure and the appended claims are also intended to include the plurality forms unless the context clearly indicates other meanings. The term “a plurality of” generally refers to at least two, but does not exclude cases in which the term refers to at least one.

It should be understood that the term “and/or” used herein merely refers to an association relationship describing associated objects, meaning that there may be three relationships. For example, the term “A and/or B” may refers to three cases including A alone, A and B together, and B alone. In addition, the character “/” used herein generally indicates an “or” relationship between the former and later associated objects.

Depending on the context, the term “if” and “supposed” used herein can be interpreted as “when” or “while” or “in response to a determination” or “in response to a recognition.” Similarly, depending on the context, the phrases “if it is determined that” or “if it is recognized that (a stated condition or event)” may be interpreted as “when it is determined” or “in response to a determination” or “when it is recognized that (a stated condition or event)” or “in response to a recognition of (a stated condition or event).”

It should also be noted that the terms “comprise,” “include” or any other variation thereof are intended to cover a non-exclusive inclusion, such that a product or a system that includes a list of elements does not only include those elements but may also include other elements not explicitly listed or also include inherent elements of the product or the system. Without further constraints, an element proceeded by the statement “comprise a(n)” does not preclude the existence of additional identical elements in the product or the system including said element.

The technical solution of the embodiments of the present disclosure may be applied to a parameter optimization scene. In a parameter optimization process, whether the subsequent parameter optimization process of the parameter is executed or not is determined by determining the test condition of a candidate parameter. The parameter optimization process is reduced, and the parameter optimization efficiency is improved.

In the conventional systems, various parameters are involved in model computing processes of machine learning models, neural network models, etc., and the parameter selection generally has significant influence on the model computing results. Therefore, some parameter optimization algorithms may be designed, and an optimum parameter is selected according to the configured parameter optimization method. In a common black box optimization algorithm, a mathematical expression of a target function is unknown, a specific computing process of the target function is unknown, but the parameter computing result that can be optimized is known. In a practical process of optimizing the parameter by using the black box optimization algorithm, a series of candidate parameters may be generated. The plurality of generated candidate parameters are respectively subjected to a parameter test by using the target function to obtain test results respectively corresponding to the plurality of candidate parameters. Then, the target parameter with the best test result is selected from the respective test results of the plurality of candidate parameters. However, by using this parameter optimization method, each of the candidate parameters needs to be subjected to the parameter test to obtain the test result of each candidate parameter. Since the process of the parameter test is complicated, a great amount of test computing is needed in the parameter optimization process, and the parameter optimization efficiency is low.

According to the embodiments of the present disclosure, in a process that the target function performs a parameter test on any candidate parameter, the parameter test of the candidate parameter is stopped to obtain an intermediate test result of the candidate parameter. If the intermediate test result of the candidate parameter does not meet the reduction condition, the parameter test of the candidate parameter is stopped. If the intermediate test result of the candidate parameter meets the parameter test, the parameter test of the candidate parameter continues to be executed to obtain the test result of the candidate parameter. The intermediate test result of the candidate parameter is monitored to confirm whether the candidate parameter needs to continue to participate in the test or not. If the test condition is not met, the parameter test of the candidate parameter is stopped. The test efficiency of the candidate parameter can be improved, the unnecessary candidate parameter test process can be reduced, and the parameter optimization efficiency can be improved.

Embodiments of the present disclosure are further illustrated in detail in conjunction with the accompanying drawings.

As shown in FIG. 1, it is a flowchart of a data processing method according to some embodiments of the present disclosure. The method may include the following steps 101, 102, 103, and 104.

In step 101, a target function corresponding to a parameter optimization request is determined in response to the parameter optimization request.

The data processing method provided by the embodiments of the present disclosure may be applied to a computing device. The computing device, for example, may include: a computer, a server, a cloud server, a super personal computer, a notebook computer, a tablet computer, etc. The specific type of the computing device is not limited in the embodiments of the present disclosure.

Optionally, the parameter test process may be a process of performing model computing on the input candidate parameter for the target function to obtain an output result, i.e., a target value of the candidate parameter. In a process that the parameter optimization or screening is practically needed, the candidate parameter sampling may be completed in an iteration manner continuously. The candidate parameters obtained through the sampling may be subjected to a parameter test to obtain a corresponding target value for each candidate parameter, and the target parameter with the optimum target value is selected from the plurality of candidate parameters after the parameter test is ended.

The parameter optimization request may include test information of the parameter test. For example, it may include function information of the target function and a parameter sampling policy. The function information of the target function, for example, may be contents capable of marking different functions such as a function name, a calling link or a function marking. The parameter sampling policy specifically may be a candidate parameter generation manner. Through the parameter sampling policy, new candidate parameters may be generated continuously. The target function may include a mathematical model or a network model, etc., and may have the “black box” characteristic. That is, the mathematical expression form of the target function is unknown, or the target function is a computing model with higher complexity and difficult to be directly described or depicted by a mathematical formula.

Optionally, the parameter optimization request may be initiated by a user. The user may provide test information of the parameter test. A user side may detect the test information of the parameter test provided by the user, generate a parameter optimization request based on the test information of the parameter test, and send the parameter optimization request to the computing device configured to perform the data processing method as shown in FIG. 1. In addition, the parameter optimization request may alternatively be automatically generated when the computing device or other clients determine that the parameter selection is needed. For example, when a condition that the target function needs the parameter selection is detected, the parameter optimization request may be generated based on the target function and the parameter sampling policy of the target function, and the parameter optimization request is provided to the computing device configured to perform the data processing method as shown in FIG. 1.

At this moment, the step may include receiving the parameter optimization request sent by the user, and after the determination result of the candidate parameter is obtained, outputting the determination result to the user to realize the parameter optimization interaction with the user.

In step 102, in a process of performing a parameter test on any candidate parameter by the target function, a test reduction module is called to determine whether the parameter test meets a reduction condition or not, to obtain a determination result.

In the embodiments of the present disclosure, the candidate parameter may be a parameter which needs to be optimized in various mathematical computing models such as a machine learning model, a neural network model, a three-dimensional computing model, a game model, etc. The candidate parameter in the embodiments of the present disclosure may be a common model parameter, a hyperparameter, a game model parameter, a data model parameter, etc. The parameter type and the parameter quantity of the candidate parameter are not limited in the embodiments of the present disclosure. The hyperparameter may be a parameter set before learning instead of a parameter in a model training process, and may also be a model parameter which is not involved in the actual training process. For example, the network depth, the number of iterations, the number of neurons per layer of the machine learning model may belong to the hyperparameter, the HP loss value under attack in a game program may also belong to the hyperparameter. Alternatively, the quantity of used query words during word query in the field of electronic commerce may also belong to the hyperparameter, and the time step and feature dimension of the market or the like in a financial market also belong to the hyperparameter.

The candidate parameter may be parameter values respectively corresponding to a plurality of sub parameters. The candidate parameter may also be referred to as a candidate parameter sample. For example, a certain candidate parameter may include parameter values respectively corresponding to three sub parameters A, B and C. When A is 0.1, B is 0.3, and C is 0.1, a candidate parameter may be formed. When A is 0.1, B is 0.3, and C is 0.15, another candidate parameter may be formed. The quantity and value of sub parameters of the candidate parameter may be set according to the practical use requirements of the parameter. As a possible implementation, the first candidate parameter may be randomly generated or obtained based on the input of a user, and the later candidate parameter may be obtained through resampling according to the historical parameter and the test result of the historical parameter. In the step of 103, if the determination result is that the parameter test meets the reduction condition, the parameter test of the candidate parameter is stopped.

In step 104, if the determination result is that the parameter test fails to meet the reduction condition, the parameter test of the candidate parameter continues to be executed to obtain the test result of the candidate parameter.

The reduction condition refers to the condition determination on whether the whole parameter test of the candidate parameter needs to be completed. Specifically, the reduction condition may be determined through the intermediate test result of the candidate parameter test, so that the test process of the candidate parameter is effectively monitored, the occurrence of an invalid parameter test is avoided, and the parameter test efficiency is improved.

In the embodiments of the present disclosure, after the target function corresponding to the parameter optimization request of the candidate parameter is determined in response to the parameter optimization request, in a process of performing a parameter test on any candidate parameter by the target function, a test reduction module may be called to determine whether a parameter test meets a reduction condition or not to obtain a determination result. If the determination result of the candidate parameter is that the candidate parameter meets the reduction condition, the parameter test of the candidate parameter is stopped. If the determination result is that the parameter test does not meet the reduction condition, the parameter test of the candidate parameter may continue to be executed to obtain the test result corresponding to the candidate parameter. The parameter test of the candidate parameter is monitored to confirm whether the candidate parameter needs to completely execute the whole parameter test or not so as to improve the test efficiency of the candidate parameter, reduce the unnecessary candidate parameter test process and improve the parameter optimization efficiency.

In the embodiments shown in FIG. 1, the parameter quantity of the candidate parameter may be one or more than one. That is, the parameter test may be performed on one candidate parameter in one step. In order to improve the test efficiency, the parameter test may also be performed on a plurality of candidate parameters at the same time. In the above one or more parameter tests, the reduction condition determination may be performed to realize the monitoring on the parameter test process of one or more candidate parameters. In addition, during the parameter test on the plurality of candidate parameters at the same time, the parameter test may be performed by using multiprocessing and software-hardware integration to further improve the parameter test efficiency.

In practical application, the technical solution of the embodiments of the present disclosure may be configured in a cloud server. The user may send a parameter optimization request through a user side to the cloud server configured to perform the data processing method as shown in FIG. 1. After receiving the request, the cloud server may execute the data processing method as shown in FIG. 1, and feed back the obtained test result to the user side, and the user side outputs the test result of the candidate parameter to the user. After the at least one candidate parameter meeting the reduction condition is additionally obtained, the test result respectively corresponding to the at least one candidate parameter may be obtained. After the target parameter meeting the optimal parameter condition is selected from the at least one candidate parameter according to the test result corresponding to the at least one candidate parameter, the target parameter may be sent to the user side, and the user side outputs the optimum target parameter to the user.

As a possible implementation, in a process of performing the parameter test on any candidate parameter by the target function, the intermediate test result of the parameter test may be obtained, and the reduction condition of the parameter test is determined through the intermediate test result.

The operation of calling the test reduction module to determine whether the parameter test meets the reduction condition or not may specifically include: monitoring the parameter test process of the candidate parameter by the target function, determining whether the target function runs to the preset monitoring node of the parameter test or not, and if so, obtaining the intermediate test result of the candidate parameter at the monitoring node.

In the parameter test process, after the target reduction algorithm determines that the parameter test runs to the monitoring node, and the intermediate test result is obtained, the parameter test may continue. When the determination result is that the parameter test meets the reduction condition, the parameter test of the candidate parameter can be stopped.

The monitoring node may be specifically set according to the test stage of the parameter test. In some embodiments, a monitoring node may be set at each parameter test stage. The parameter test stage may include: a phase I stage test period, a phase II stage test period, and a phase III stage test period. Each of the parameter test stages may be set according to the computing process of the target function, and specifically, the target function may be divided into a phase I function, a phase II function and a phase III function according to a calculation sequence. A computing stage of the phase I function may be the phase I stage test period. The first monitoring node may be set at the computing result position of the phase I function, or the monitoring node may be set in the middle of the computing process of the phase I function. A computing stage of the phase II function may be a phase II stage test period. The second monitoring node may be set at the computing result position of the phase II function, or the monitoring node may be set in the middle of the computing process of the phase II function. A computing stage of the phase III function may be a phase III stage test period. The computing result of the phase III function is the test result, and it is possible to not set the monitoring node, or set the monitoring node in the middle of the computing process of the phase III function. The monitoring node may be specifically set according to practical monitoring requirements. Through the division of the early, middle and phase III stage test periods, different test stages of the parameter test may be monitored in a targeted manner, and the efficient and effective monitoring is realized.

As another possible implementation, in a process of performing the parameter test on any candidate parameter by the target function, the operation of obtaining the intermediate test result of the candidate parameter may include: in a process of performing the parameter test on any candidate parameter by the target function, when the current executing result meets the monitoring condition according to a detection result, obtaining the intermediate test result of the candidate parameter. The monitoring condition may be set according to a specific process of the test and monitoring requirements. For example, the monitoring condition may be that the number of iterations reaches an iteration threshold.

In practical applications, the test reduction module may provide a plurality of test reduction algorithms. The test reduction module may be a program or sub program for executing a function of determining whether the parameter test meets the reduction condition or not, and the test reduction module may provide an interface associated with an external environment to realize the data or information transmission.

The test reduction module may be configured in the computing device of the embodiments as shown in FIG. 1 or directly configured in the reduction device. The reduction device may be a device different from the computing device configured to perform the data processing method provided in the embodiments as shown in FIG. 1. Specifically, the reduction device may be a computer, a server, a cloud server, a super personal computer, a notebook computer, a tablet computer, etc. The specific type of the reduction device is not limited in the embodiments of the present disclosure.

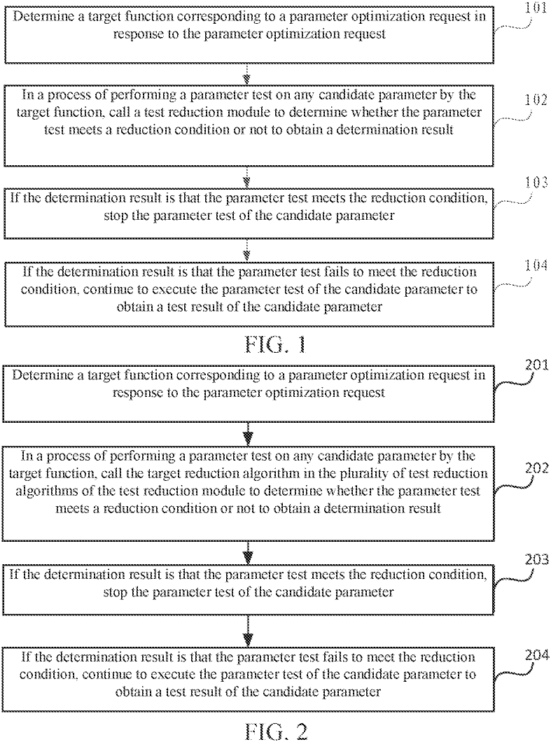

As shown in FIG. 2, it is a flowchart of a data processing method according to some other embodiments of the present disclosure. The method may include the following steps 201, 202, 203, and 204.

In step 201, a target function corresponding to a parameter optimization request is determined in response to the parameter optimization request.

Parts of steps in the embodiments of the present disclosure are the same as steps in the embodiments as shown in FIG. 1, and are not repeated herein for the simplicity of the description.

Operationally, when the parameter optimization request is initiated by the user, the target function may be automatically matched for the parameter optimization request initiated by the user, or the target function may be determined by the user. When the target function is determined by the user, an input interface of the target function may be provided. The user side may detect the target function input by the user, and transmit the target function to the computing device executing the data processing method.

Optionally, before determining a target function corresponding to a parameter optimization request in response to the parameter optimization request, the operation may further include: detecting the parameter optimization request triggered by the user for any black box optimization algorithm. The operation of determining the target function corresponding to a parameter optimization request in response to the parameter optimization request may include: determining the target function corresponding to the black box optimization algorithm selected by the user in response to the parameter optimization request.

In step 202, in a process of performing a parameter test on any candidate parameter by the target function, the target reduction algorithm in the plurality of test reduction algorithms of the test reduction module is called to determine whether the parameter test meets a reduction condition or not, to obtain a determination result.

The test reduction policy may include a plurality of test reduction algorithms. One target reduction algorithm may be selected from the plurality of test reduction algorithms to determine whether the parameter test meets the reduction condition or not. The plurality of provided test reduction algorithms may be matched with different parameter tests, which increases more options of the reduction algorithms and provides a greater range of choices.

In step 203, if the determination result is that the parameter test meets the reduction condition, the parameter test of the candidate parameter is stopped.

In step 204, if the determination result is that the parameter test fails to meet the reduction condition, the parameter test of the candidate parameter continues to be executed to obtain the test result of the candidate parameter.

In the embodiments of the present disclosure, after the target function corresponding to the parameter optimization request of the candidate parameter is determined in response to the parameter optimization request, in a process of performing a parameter test on any candidate parameter by the target function, a target reduction algorithm in a test reduction module may be called to determine whether a parameter test meets a reduction condition or not, to obtain a determination result. If the determination result of the candidate parameter is that the candidate parameter meets the reduction condition, the parameter test of the candidate parameter is stopped. By determining the target reduction algorithm, the parameter test may be accurately determined to obtain a precise determination result. If the determination result is that the parameter test fails to meet the reduction condition, the parameter test of the candidate parameter may continue to be executed to obtain the test result corresponding to the candidate parameter. The parameter test of the candidate parameter is monitored to confirm whether it is needed to completely execute the whole parameter test or not for the candidate parameter so as to improve the test efficiency of the candidate parameter, reduce the unnecessary candidate parameter test process and improve the parameter optimization efficiency.

As an example, the target reduction algorithm may be determined from the plurality of test reduction algorithms by searching the target reduction algorithm matched with the parameter test from the plurality of test reduction algorithms of the test reduction module.

The determination step of the target reduction algorithm may be executed at one side of the computing device, and may also be executed at one side of the device configured with a test reduction module.

Optionally, the operation of calling, in a process of performing the parameter test on any candidate parameter by the target function, the test reduction module to determine whether a parameter test meets a reduction condition or not to obtain a determination result may include: generating a determination request for determining whether the parameter test meets the reduction condition or not; and sending the determination request to the test reduction module so that the test reduction module determines, in response to the determination request, whether the parameter test meets the reduction condition or not.

Specific generation manners of the determination request may include various types, different generation manners may correspond to different response manners, and a plurality of generation manners of the determination request will be illustrated hereafter.

In the first generation manner, the determination request may be generated from a test handle or a test mark for performing the parameter test on the candidate parameter by the target function. The test reduction module may monitor the parameter test to obtain an intermediate test result of the parameter test, and determine whether the intermediate test result meets the reduction condition or not.

In the second generation manner, in a process that the target function performs a parameter test on any candidate parameter, the intermediate test result of the candidate parameter may be obtained, and the determination request is generated based on the intermediate test result. The test reduction module may determine whether the intermediate test result meets the reduction condition or not after obtaining the intermediate test result in the determination request.

In the third generation manner, in a process that the target function performs a parameter test on any candidate parameter, a determination request may be generated on the target reduction algorithm. After the test reduction module obtains the target reduction algorithm in the determination request, the target reduction algorithm may be fed back. The computing device obtains the target reduction algorithm of the determination request, and may perform the reduction determination on the parameter test of the candidate parameter using the target reduction algorithm, and specifically, the determination may be performed according to the intermediate test result of the candidate parameter.

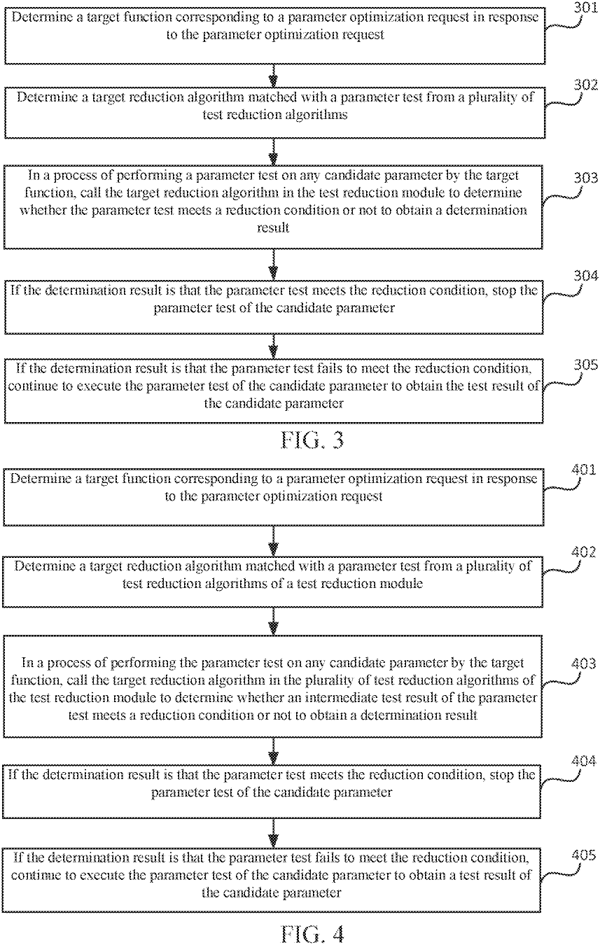

The target reduction algorithm may be executed at the side of the computing device. As shown in FIG. 3, it is a flowchart of a data processing method according to some other embodiments of the present disclosure. The method may include the following steps 301, 302, 303, 304, and 305.

In step 301, a target function corresponding to a parameter optimization request is determined in response to the parameter optimization request.

In step 302, the target reduction algorithm matched with the parameter test is determined from the plurality of test reduction algorithms.

In step 303, in a process of performing a parameter test on any candidate parameter by the target function, a target reduction algorithm in a test reduction module is called to determine whether the parameter test meets a reduction condition or not, to obtain a determination result.

In step 304, if the determination result is that the parameter test meets the reduction condition, the parameter test of the candidate parameter is stopped.

In step 305, if the determination result is that the parameter test fails to meet the reduction condition, the parameter test of the candidate parameter continues to be executed to obtain the test result of the candidate parameter.

Optionally, the operation of determining the target reduction algorithm matched with the parameter test from the plurality of test reduction algorithms may include: showing the plurality of test reduction algorithms for the user, and obtaining the target reduction algorithm selected by the user from the plurality of test reduction algorithms.

In the embodiments of the present disclosure, in a process of performing a parameter test on any candidate parameter by the target function, the target reduction algorithm of the test reduction module may be called to determine whether the parameter test meets the reduction condition or not, to obtain the determination result. Then, the plurality of test reduction algorithms are determined. The target reduction algorithm matched with the parameter test is determined from the plurality of test reduction algorithms, to provide available test reduction algorithm, and effectively guarantee the parameter reduction scheme to ensure that it can be adapted to different parameter tests. The application range of the parameter reduction is effectively expanded, and the utilization efficiency of the parameter reduction is improved. After the target reduction algorithm is determined, whether the parameter test of the candidate parameter meets the reduction condition or not may be determined according to the target reduction algorithm. If the parameter test of the candidate parameter meets the reduction condition, the test parameter of the candidate parameter is stopped. If the parameter test of the candidate parameter fails to meet the reduction condition, the test parameter of the candidate parameter continues to be executed to obtain the test result of the candidate parameter. By effective test condition determination on the candidate parameter, invalid parameter tests of the candidate parameter can be reduced, the time loss of the parameter test is reduced, and the test efficiency of the parameter test is improved.

As an example, the operation of searching the target reduction algorithm matched with the parameter test from the plurality of test reduction algorithms of the test reduction module may include: determining first test information corresponding to the parameter test of the candidate parameter; obtaining second test information respectively associated with the plurality of test reduction algorithms is obtained; searching target test information matched with the first test information from the second test information respectively corresponding to the plurality of test reduction algorithms; and determining the test reduction algorithm corresponding to the target test information as the target reduction algorithm.

Optionally, the test reduction algorithm may be the reduction policy on the test process of the candidate parameter. That is, the test reduction algorithm may be used to estimate the training effect on the candidate parameter in the parameter test process of the candidate parameter so as to determine whether it is needed to continue to perform the parameter test or not for the candidate parameter.

Optionally, the test information may be attribute information relevant to the parameter test. The test information of different parameter tests may be defined by using test attribute information. The first test information may be attribute information of the parameter test of the candidate parameter. The second test information may be attribute information of the parameter test applicable to the corresponding test reduction algorithm.

The first test information may be node information of the test monitoring node defined by the parameter test of the candidate parameter, the parameter test type corresponding to the parameter test of the candidate parameter and/or the parameter test stage corresponding to the parameter test of the candidate parameter.

Any piece of second test information may include: one or more of the node information of the test monitoring node, the parameter test type, and the parameter test stage applicable to the corresponding test reduction algorithm.

The node information of the test monitoring node may be specifically a mapping relationship or a mapping target of a corresponding function of the target function at the test monitoring node. The test reduction algorithm matched with the node information may be built, a corresponding association relationship is set for the node information and the test reduction algorithm set for the node information, and the target reduction policy matched with the node information of the test monitoring node may be searched through the association relationship. For example, the hyperparameter to be optimized is the network depth, and the mapping relationship of the function corresponding to the monitoring node is the feature extraction dimension and the reliability influence. Assuming that the influence of the feature extraction dimension is that with the network depth increasing, the reliability of the extracted feature is higher if the extracted feature dimension is higher, the test reduction algorithm may be set to realize that the feature dimension is smaller than a dimension threshold, and the feature reliability is higher than a precision threshold.

For a specific example, assuming that the dimension threshold set by the test reduction algorithm is 500, the reliability is 85%, if the feature dimension of the network depth extraction of the candidate parameter of 10 is 1000, and the reliability is 70%, at this moment, the candidate parameter of 10 does not meet the reduction condition, and the parameter test of the candidate parameter of 10 may be stopped. If the candidate parameter is 5, the extracted feature dimension is 500, and the reliability is 90%, at this moment, the candidate parameter of 5 may meet the reduction condition, and the parameter test of the candidate parameter of 5 may be continued to obtain the final test result.

For another example, the HP loss value in a game scene may be a to-be-optimized parameter. Considering the user experience in the game, the HP loss value being too high may cause a short game time, and the HP loss value being too low may reduce the game’s entertainment value. In order to obtain the HP loss value with a proper balance between both the game time and the game’s entertainment value, the user may define the interruption information of the HP loss value while estimating the use effect of the HP loss value, and the target reduction algorithm is set for the interruption information.

For another example, in an electronic commerce scene, during content recommendation for the user, a plurality of sub parameters may be used to respectively represent features such as browsing behaviors, click habits, etc. of the user for obtaining the target recommendation content. The weighted sum of the feature information respectively corresponding to the plurality of sub parameters using the weight of each sub parameter as the proportion may be used as a searching feature of the user target recommendation content. The respective proportions of the sub parameters may be used as a candidate parameter to be optimized. In a process of the parameter test of the candidate parameter, one ratio respectively corresponding to the sub parameters is preset and may be used as a candidate parameter. During the parameter test on the candidate parameter, the detection feature of the user may be specifically determined through the candidate parameter. The target recommendation content may be searched for the user based on the searching feature, and then, the click rate of the user on the target recommendation content is predicted to determine whether the current determined ratio respectively corresponding to the sub parameters may be used as a final result or not. Generally, the above test process is complicated, and the computing amount is great. In order to reduce the computing amount, in the process of the parameter test, the “target recommendation content searched for the user based on the current searching feature” may be used as a monitoring node, and whether the target recommendation content meets the reduction condition or not is determined. For example, the similarity of the target recommendation content to the current searching feature is determined. If the similarity is lower than a preset similarity threshold, it may be confirmed that the target recommendation content obtained through searching based on the current searching feature may be inaccurate, and it is unnecessary to execute the subsequent click rate prediction process. At this moment, the current parameter test of the candidate parameter is stopped. The generation and the parameter test of a next candidate parameter may be continued. The unnecessary parameter test is reduced, and the parameter test efficiency may be improved.

Optionally, because there may be a plurality of test reduction algorithms, different algorithm marks may be used to distinguish the test reduction algorithms. When the algorithm marks of the test reduction algorithms are known, if the specific algorithm logics of the test reduction algorithms are also known, the test information suitable for each test reduction algorithm may be recorded in detail. Accordingly, the method may further include: generating second test information respectively for the plurality of test reduction algorithms. The test information may include: one or more of the node information of the test monitoring node, the parameter test type, and the parameter test stage. Therefore, the second test information capable of respectively corresponding to the plurality of test reduction algorithms may include: applicable node information, zero, one or more applicable parameter test types, and/or zero, one or more applicable parameter test stages.

Any candidate parameter may have the corresponding parameter test type. The corresponding reduction algorithm may be set according to the parameter test type. As a possible implementation, the first test information may include the parameter test type.

Optionally, the operation of searching the target test information matched with the first test information from the second test information respectively corresponding to the plurality of test reduction algorithms may include: searching the target test information matched with the parameter test type of the first test information from the second test information respectively corresponding to the plurality of test reduction algorithms.

The plurality of test reduction algorithms may respectively correspond to the second test information. The second test information may be attribute information of the parameter test applicable to the test reduction algorithm, and may be specifically list information of the test attribute information applicable to the test reduction algorithm. Through the second test information respectively corresponding to the plurality of test reduction algorithms, the second test information with the parameter test type of the first test information may be searched to obtain the target test information matched with the first test information.

In a possible design, the parameter test type may include: a serial test type and a parallel test type.

Optionally, the operation of searching the target test information matched with the parameter test type of the first test information from the second test information respectively corresponding to the plurality of test reduction algorithms may include: in response to the parameter test type of the candidate parameter being the serial test type, determining the target test information with the serial test type in the second test information respectively corresponding to the plurality of test reduction algorithms; or in response to the parameter test type of the candidate parameter being the parallel test type, determining the target test information with the parallel test type in the second test information respectively corresponding to the plurality of test reduction algorithms.

The operation of determining the target test information with the serial test type in the second test information respectively corresponding to the plurality of test reduction algorithms may include: searching the target test information with the serial test type in the second test information corresponding to the plurality of test reduction algorithms. Any test reduction algorithm corresponds to the second test information. If the second test information of a certain test reduction algorithm includes the serial test type, it shows that the test reduction algorithm is applicable to the parameter test of the serial test type, and the test reduction algorithm may be determined to be the target reduction algorithm.

The operation of determining the target test information with the parallel test type in the second test information respectively corresponding to the plurality of test reduction algorithms may include: searching the target test information with the parallel test type in the second test information corresponding to the plurality of test reduction algorithms. Any test reduction algorithm corresponds to the second test information. If the second test information of a certain test reduction algorithm includes the parallel test type, it shows that the test reduction algorithm is applicable to the parameter test of the parallel test type, and the test reduction algorithm may be determined to be the target reduction algorithm.

As further another possible implementation, the first test information may include a parameter test stage.

Optionally, the operation of searching the target test information matched with the first test information from the second test information respectively corresponding to the plurality of test reduction algorithms may include: searching the target test information matched with the parameter test stage of the first test information from the second test information respectively corresponding to the plurality of test reduction algorithms.

In a possible design, the parameter test stage may include: a phase I stage test period, a phase II stage test period, and a phase III stage test period.

Optionally, the operation of searching the target test information matched with the parameter test stage of the first test information from the second test information respectively corresponding to the plurality of test reduction algorithms may include: if the parameter test stage of the candidate parameter is the phase I stage test period, determining the target test information with the phase I stage test period in the second test information respectively corresponding to the plurality of test reduction algorithms; or if the parameter test stage of the candidate parameter is the phase II stage test period, determining the target test information with the phase II stage test period in the second test information respectively corresponding to the plurality of test reduction algorithms; or if the parameter test stage of the candidate parameter is the phase III stage test period, determining the target test information with the phase III stage test period in the second test information respectively corresponding to the plurality of test reduction algorithms.

The operation of determining the target test information with the phase I stage test period in the second test information respectively corresponding to the plurality of test reduction algorithms may include searching the target test information with the phase I stage test period in the second test information corresponding to the plurality of test reduction algorithms. Any test reduction algorithm corresponds to the second test information. If the second test information of a certain test reduction algorithm includes the phase I stage test period, it shows that the test reduction algorithm is applicable to the parameter test of the phase I stage test period, and the test reduction algorithm may be determined to be the target reduction algorithm.

The operation of determining the target test information with the phase II stage test period in the second test information respectively corresponding to the plurality of test reduction algorithms may include searching the target test information with the phase II stage test period in the second test information corresponding to the plurality of test reduction algorithms. Any test reduction algorithm corresponds to the second test information. If the second test information of a certain test reduction algorithm includes the phase II stage test period, it shows that the test reduction algorithm is applicable to the parameter test of the phase II stage test period, and the test reduction algorithm may be determined to be the target reduction algorithm.

The operation of determining the target test information with the phase III stage test period in the second test information respectively corresponding to the plurality of test reduction algorithms may include: searching the target test information with the phase III stage test period in the second test information corresponding to the plurality of test reduction algorithms. Any test reduction algorithm corresponds to the second test information. If the second test information of a certain test reduction algorithm includes the phase III stage test period, it shows that the test reduction algorithm is applicable to the parameter test of the phase III stage test period, and the test reduction algorithm may be determined to be the target reduction algorithm.

In addition, the serial test type and the parallel test type are listed for the parameter test types in the embodiments of the present disclosure. In practical applications, in addition to the serial test type and the parallel test type, other parameter test types, such as a sampling test type performing the parameter test after sampling the plurality of candidate parameters, may further be included. The parameter test types are not limited in the embodiments of the present disclosure.

The parameter test stage is also divided in the embodiments of the present disclosure, and is specifically divided into a phase I stage test period, a phase II stage test period, and a phase III stage test period. In practical applications, the division of the parameter test stage is performed according to the specific computing process of the test process and the test time. The stage division manner in the embodiments of the present disclosure is only illustrative, and does not constitute the specific limitation to the test stage division in the present disclosure, and any stage division through the test time, test computing content or process may belong to the stage division solution protected by the embodiments of the present disclosure.

As another possible test manner, the first test information may further include a parameter test stage and a parameter test type.

Optionally, the operation of searching the target test information matched with the first test information from the second test information respectively corresponding to the plurality of test reduction algorithms may include determining the target test information matched with the parameter test type and the parameter test stage at the same time from the second test information respectively corresponding to the plurality of test reduction algorithms.

In yet a possible design, the parameter test type may include a parallel test type and a serial test type. The parameter test stage may include a phase I stage test period, a phase II stage test period, and a phase III stage test period.

Target test information matched with the parameter test type and the parameter test stage at the same time is determined from the second test information respectively corresponding to the plurality of test reduction algorithms.

By regarding the parameter test stage and the parameter test type as the selection basis of the reduction algorithm at the same time, the obtained target reduction algorithm may meet the requirements of the parameter test type and the parameter test stage, and the target reduction algorithm meeting more reduction requirements is provided.

As further another embodiment, the plurality of test reduction algorithms include a self-defined reduction algorithm set by a target user.

The target reduction algorithm may also be determined in a following manner from the plurality of test reduction algorithms: in response to the self-defined reduction algorithm set by a target user existing in the plurality of test reduction algorithms, determining the self-defined reduction algorithm as the target reduction algorithm.

The first test information may further include a self-defined mark set by the target user for the parameter test of the candidate parameter. The self-defined mark is used to mark whether the target user sets the self-defined reduction algorithm or not. If the self-defined mark is true, it is directly confirmed that the self-defined reduction algorithm set by the target user for the candidate parameter exists in the plurality of test reduction algorithms, and the self-defined reduction algorithm set by the target user may be used as the target reduction algorithm. If the self-defined mark is false, it is determined that the target user does not set the self-defined algorithm. At this moment, the target test information matched with the first test information may be searched from the second test information respectively corresponding to the plurality of test reduction algorithms.

As an example, the method may further include: based on the self-defined reduction algorithm set by the target user, controlling the test reduction module to store the self-defined reduction algorithm.

Optionally, an input interface of the reduction algorithm may be provided, and the reduction algorithm input by the user in the interface may be the self-defined reduction algorithm. By providing the self-defined reduction algorithm, the applicability of the reduction algorithm may be increased, and the reduction algorithm is applicable to the reduction of various types of parameter tests, and the test reduction range is expanded. The input interface of the reduction algorithm may be shown by the computing device configured to perform the data processing method provided by the embodiments of this disclosure for the user who needs to perform the parameter optimization, and may also be provided for the user by the reduction module to obtain the self-defined reduction algorithm input by the user. After the computing device obtains the self-defined reduction algorithm, the self-defined reduction algorithm may be sent to the test reduction module to be stored by the test reduction module. The test reduction module may store the self-defined reduction algorithm when detecting the self-defined reduction algorithm input by the user.

In some embodiments, the operation of determining the self-defined reduction algorithm as the target reduction algorithm in response to the self-defined reduction algorithm set by a target user existing in the plurality of test reduction algorithms may further include: in response to the self-defined reduction algorithm set by a target user existing in the plurality of test reduction algorithms, generating prompt information showing existence of the self-defined reduction algorithm; showing the prompt information to the target user for the target user to confirm whether the self-defined algorithm is applicable to the parameter test or not; and determining the self-defined reduction algorithm as the target reduction algorithm in response to the target user executing a confirming operation for the self-defined reduction algorithm applicable to the parameter test.

By providing prompts about the self-defined reduction algorithm for the user, the user is enabled to effectively monitor the reduction policy of the parameter test, and the effective interaction of the reduction algorithm is realized.

In some embodiments, the candidate parameter may be a parameter needing the parameter test. Through the parameter test, the use effect of the candidate parameter may be estimated, and the parameter test result is obtained.

As an embodiment, the operation of in a process of performing a parameter test on any candidate parameter by the target function, calling the test reduction module to determine whether an intermediate test result of the parameter test meets a reduction condition or not to obtain a determination result may include: in the process of performing the parameter test on any candidate parameter by the target function, calling the test reduction module to determine whether the intermediate test result of the parameter test meets the reduction condition or not to obtain the determination result.

The intermediate test result of the parameter test is obtained, and whether the intermediate test result meets the reduction condition of the parameter test or not is determined to determine whether the candidate parameter may continue to participate in the subsequent parameter test or not.

In a possible design, the monitoring node of the parameter test of the candidate parameter may be set. In the parameter test of the candidate parameter, a plurality of monitoring nodes may be set to monitor a plurality of nodes. The operation of in a process of performing a parameter test on any candidate parameter by the target function, obtaining the intermediate test result of the parameter test may include: in a process of performing the parameter test on any candidate parameter by the target function, obtaining the corresponding intermediate test result of the candidate parameter at the at least one monitoring node.

As a possible implementation, the condition that the intermediate test result of the candidate parameter meets the reduction condition may be specifically that: when any intermediate test result in the at least one intermediate test result of the candidate parameter meets the reduction condition, the candidate parameter meets the reduction condition, and the parameter test of the candidate parameter may be stopped.

As another possible implementation, the condition that the intermediate test result of the candidate parameter fails to meet the reduction condition may be specifically that: when the at least one intermediate test result of the candidate parameter all fails to meet the reduction condition, the candidate parameter fails to meet the reduction condition, and the parameter test of the candidate parameter continues to be executed to obtain the test result.

In practical applications, the candidate parameter may be in any parameter test type in a plurality of parameter test types. The common parameter test types may include: a serial test type and a parallel test type. The serial test type may refer to that one candidate parameter is generated in each test, and the candidate parameter generated in each test is subjected to the parameter test. The parallel test type may refer to that a plurality of candidate parameters are generated in each test, and the plurality of candidate parameters are subjected to the parameter test at the same time. The candidate parameter in the embodiments of the present disclosure may be the candidate parameter generated in the serial test type, and may also be the candidate parameter generated in the parallel test type.

In some embodiments, the operation of in a process of performing a parameter test on any candidate parameter by the target function, calling the test reduction module to determine whether an intermediate test result of the parameter test meets a reduction condition or not to obtain the determination result may include: in a process of performing a parameter test on any candidate parameter by the target function, calling the target reduction algorithm in the plurality of test reduction algorithms of the test reduction module to determine whether an intermediate test result of the parameter test meets a reduction condition or not to obtain a determination result.

As shown in FIG. 4, it is a flowchart of a data processing method according to some other embodiments of the present disclosure. The method may include the following steps 401, 402, 403, 404, and 405.

In step 401, a target function corresponding to a parameter optimization request is determined in response to the parameter optimization request.

In step 402, the target reduction algorithm matched with the parameter test is searched from the plurality of test reduction algorithms of the test reduction module.

In step 403, in a process of performing a parameter test on any candidate parameter by the target function, the target reduction algorithm in the plurality of test reduction algorithms of the test reduction module is called to determine whether an intermediate test result of the parameter test meets a reduction condition or not to obtain a determination result.

In step 404, in response to the determination result being that the parameter test meets the reduction condition, the parameter test of the candidate parameter is stopped.

In step 405, in response to the determination result being that the parameter test fails to meet the reduction condition, the parameter test of the candidate parameter continues to be executed to obtain the test result of the candidate parameter.

In the embodiments of the present disclosure, the target function corresponding to the parameter optimization request is determined in response to the parameter optimization request, and the target reduction algorithm matched with the parameter test may be searched from the plurality of test reduction algorithms of the plurality of test reduction modules. By providing the option of the plurality of test reduction algorithms, the use condition of the test reduction algorithms may be expanded, the application scene of the test reduction algorithms is improved, and the multi-dimensional application is realized. In a process of performing a parameter test on any candidate parameter by the target function, the target reduction algorithms in the plurality of test reduction algorithms of the test reduction model may be called to determine whether the intermediate test result in the test reduction algorithms meets the reduction condition or not to obtain the determination result. If the determination result is that the parameter test meets the reduction condition, the parameter test of the candidate parameter may be stopped. If the determination result is that the parameter test does not meet the reduction condition, the parameter test of the candidate parameter may continue to be executed to obtain the test result of the candidate parameter. The accurate determination is realized by accurately determining whether the intermediate test result of the candidate parameter meets the reduction condition or not.

The test reduction algorithms may be methods for performing effect estimation on the intermediate test result of the candidate parameter. In practical applications, a plurality of test reduction algorithms may be provided at the same time, and the target reduction algorithm matched with the current test information may be selected from the plurality of test reduction algorithms.

In some embodiments, the target reduction algorithm may include a historical estimation algorithm.

Optionally, the historical estimation algorithm determines whether the intermediate test result meets the reduction condition or not specifically in the following manner: according to historical intermediate results and historical test results respectively corresponding to a plurality of historical parameters, estimating an estimated test result corresponding to the intermediate test result; determining whether the estimated test result is matched with a result threshold or not; in response to a determination that the estimated test result is not matched with the result threshold, determining that the intermediate test result meets the reduction condition; or in response to a determination that the estimated test result is matched with the result threshold, determining that the intermediate test result fails to meet the reduction condition.

Optionally, the operation of estimating, according to historical intermediate results and historical test results respectively corresponding to a plurality of historical parameters, an estimated test result corresponding to the intermediate test result may include: obtaining a historical intermediate result generated by the plurality of historical parameters at the monitoring node interrupting the parameter test of the candidate parameter; and according to the intermediate test result and the historical intermediate result respectively corresponding to the plurality of historical parameters, estimating the estimated test result corresponding to the intermediate test result in combination with the historical test results respectively corresponding to the plurality of historical parameters.

Optionally, the operation of determining whether the estimated test result is matched with the result threshold or not may specifically include: determining whether the estimated test result is greater than the result threshold or not; or determining whether the estimated test result is smaller than the result threshold or not. The value relationship between the estimated test result and the result threshold may be determined according to the specific type of the target function of the parameter test.

In a possible design, the operation of estimating, according to the intermediate test result and the historical intermediate results respectively corresponding to the plurality of historical parameters, the estimated test result corresponding to the intermediate test result in combination with the historical test results respectively corresponding to the plurality of historical parameters may specifically include: according to the historical test results and the historical intermediate results respectively corresponding to the plurality of historical parameters, determining the mapping relationship between the intermediate result and the test result; and according to the mapping relationship between the intermediate result and the test result, determining the estimated test result corresponding of the intermediate test result.

Further, optionally, the operation of according to the historical test results and the historical intermediate results respectively corresponding to the plurality of historical parameters, determining the mapping relationship between the intermediate result and the test result may include: performing a curve fitting to the historical intermediate results respectively corresponding to the plurality of historical parameters to obtain an intermediate result curve; performing a curve fitting to the historical test results respectively corresponding to the plurality of historical parameters to obtain a test result curve; and determining the mapping relationship between the intermediate result and the test result according to the test result curve and the intermediate result curve.

The estimated test result corresponding to the intermediate test result is obtained by the result estimation method, so that whether the intermediate test result meets the reduction condition or not may be promptly determined by using the estimated test result, and the result estimation accuracy is improved.

In some embodiments, the target reduction algorithm may further include: a computational comparison algorithm.

The computational comparison algorithm determines whether the intermediate test result meets the reduction condition or not specifically in the following manner: determining an intermediate reference value corresponding to a monitoring node for obtaining the intermediate test result in the parameter test process; determining whether the intermediate reference value meets a preset reference threshold or not; in response to a determination that the intermediate reference value fails to meet the preset reference threshold, determining that the intermediate test result meets the reduction condition; or in response to a determination that the intermediate reference value meets the preset reference threshold, determining that the intermediate test result fails to meet the reduction condition.

Optionally, the intermediate reference value may be determined according to the historical test results of the plurality of historical parameters at the monitoring node. The intermediate reference value may be specifically determined through weighted sum, mean value computing, variance computing, etc.

Difference value comparison may be performed between a mean value of the intermediate reference value and the intermediate test value, so that whether the intermediate test result meets the reduction condition or not is determined through the comparison result. At this moment, the step of determining whether the intermediate reference result meets the preset reference threshold or not may include: determining whether the difference value of the intermediate reference value and the intermediate test value is smaller than a preset difference value threshold or not. If so, it is determined that the intermediate test result meets the reduction condition. Otherwise, it is determined that the intermediate test result fails to meet the reduction condition. Alternatively, in some embodiments, it may be determined that whether the difference value is greater than the preset difference value threshold or not. If so, it is determined that the intermediate test result meets the reduction condition. Otherwise, it is determined that the intermediate test result fails to meet the reduction condition. The specific condition may be determined according to the practical use requirements.

The variance value of the intermediate test result may be obtained through calculation of the mean value of the intermediate reference value and the intermediate test result, to obtain the variance of the intermediate test result. The stability of the intermediate test result and the difference between the practical value and the mean value can be measured through the variance value. A greater variance value shows a more stable intermediate test result, while a smaller square value shows a more instable intermediate test result and more deviation from the intermediate test result. At this moment, the operation of determining whether the intermediate reference value meets the preset reference threshold or not may specifically include: determining whether the intermediate variance is smaller than a variance threshold or not. If so, it may be determined that the intermediate test result meets the reduction condition. Otherwise, it may be determined that the intermediate test result fails to meet the reduction condition. Alternatively, it may be determined that whether the intermediate variance is greater than the variance threshold or not. If so, it is determined that the intermediate test result meets the reduction condition. Otherwise, it is determined that the intermediate test result fails to meet the reduction condition. The specific condition may be determined according to the practical use requirements.

Optionally, the historical estimation algorithm and the computational comparison algorithm may both belong to the plurality of test reduction algorithms, and the historical estimation algorithm and the computational comparison algorithm may both correspond to the second test information. When the historical estimation algorithm or the computational comparison algorithm is the target reduction algorithm, it may be determined that the second test information of the historical estimation algorithm is matched with the first test information corresponding to the parameter test of the candidate parameter, or it may be determined that the second test information of the computational comparison algorithm is matched with the first test information corresponding to the parameter test of the candidate parameter. The second test information corresponding to the historical estimation algorithm and the second test information of the computational comparison algorithm may be confirmed according to the specific test attribute information of the corresponding parameter test.

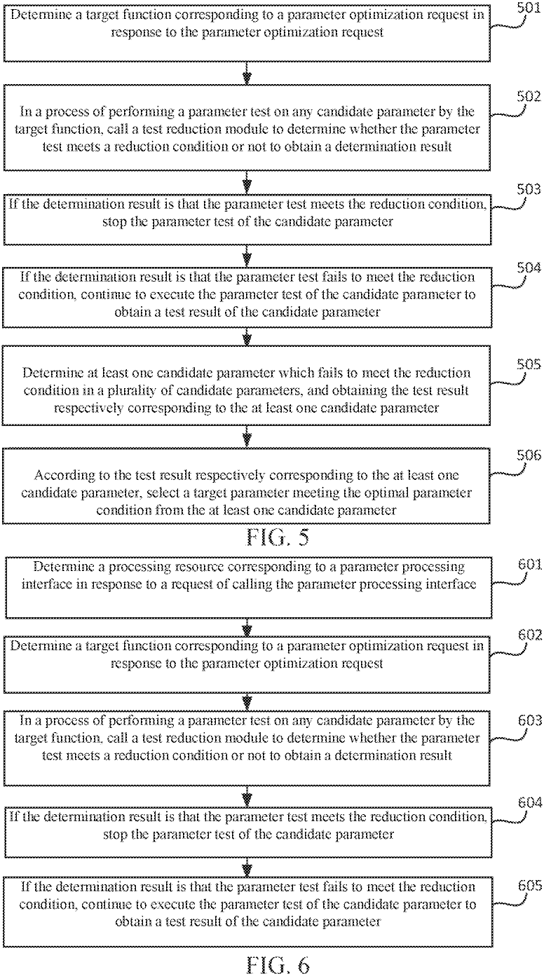

As shown in FIG. 5, it is a flowchart of a data processing method according to some other embodiments of the present disclosure. The method may include the following steps 501, 502, 503, 504, 505, and 506.

In step 501, a target function corresponding to a parameter optimization request is determined in response to the parameter optimization request.

Parts of steps in the embodiments of the present disclosure are the same as parts of steps in the above-mentioned embodiments, and are not repeated herein for the description simplicity.

In step 502, in a process of performing a parameter test on any candidate parameter by the target function, a test reduction module is called to determine whether the parameter test meets a reduction condition or not to obtain a determination result.

In step 503, in response to the determination result being that the parameter test meets the reduction condition, the parameter test of the candidate parameter is stopped.

In step 504, in response to the determination result being that the parameter test fails to meet the reduction condition, the parameter test of the candidate parameter continues to be executed to obtain the test result of the candidate parameter.

In step 505, at least one candidate parameter which fails to meet the reduction condition is determined, and the test result respectively corresponding to the at least one candidate parameter is obtained.

In step 506, according to the test result respectively corresponding to the at least one candidate parameter, the target parameter meeting the optimal parameter condition is selected from the at least one candidate parameter.

According to the embodiments of the present disclosure, in a process that the target function performs a parameter test on any candidate parameter, the intermediate test result of the candidate parameter is obtained. If the intermediate test result of the candidate parameter meets the reduction condition, the parameter test of the candidate parameter may be stopped. If the intermediate test result of the candidate parameter does not meet the reduction condition, the parameter test of the candidate parameter continues to be executed to obtain the test result of the candidate parameter. The parameter test of the candidate parameter is determined and verified to confirm whether to continue to execute the parameter test of the candidate parameter. The parameter test of the unnecessary candidate parameter can be reduced, and the time loss of the parameter test of the candidate parameter is reduced. Therefore, at least one candidate parameter which does not meet the reduction condition can be determined, and the test result respectively corresponding to the at least one candidate parameter is obtained. According to the test result respectively corresponding to the at least one candidate parameter, the target parameter meeting the optimal parameter condition is selected from the at least one candidate parameter. The at least one candidate parameter meeting the reduction condition is used as a parameter selection basis, which reduces the parameter space complexity, and improves the parameter selection efficiency and effectiveness.

Optionally, the test result information may be generated for any candidate parameter. During the parameter test on any candidate parameter by the target function, a test mark may be generated for the candidate parameter, and the parameter tests of different candidate parameters can be marked through the test mark. In addition, in the embodiments of the present disclosure, the test is interrupted in the parameter test process of the candidate parameter. After the test condition is determined, the candidate parameter may stop participating in the parameter test and may continue to participate in the parameter test. In order to distinguish the candidate parameter completing the parameter test and the candidate parameter not completing the parameter test, test state information may be set for the candidate parameter. The test state information may include: testing, completed or reduced. “Testing” refers to that the parameter test of the candidate parameter is proceeding. “Completed” may mark that the candidate parameter has completed the parameter test and obtained the corresponding test result. “Reduced” may mark that the candidate parameter does not complete the parameter test, and practically has no test result. Therefore, in order to distinguish the parameter tests, test results and reduction results of different candidate parameters, the method may further include: generating first test information for the parameter test of the candidate parameter. The test result information of the candidate parameter may include: a test mark, a candidate parameter, a test result and test state information.

When the test state information of any candidate parameter is reduced, a poor test result may be directly set for the candidate parameter to directly distinguish the test result obtained by the candidate parameter completing the parameter test. For example, assuming that the test result obtained by the candidate parameter completing the parameter test is between 0.5 and 0.95, a test result of 0.01 to 0.1 may be set for the candidate parameter with the test state information being reduced, so that the candidate parameters of different test state information can be directly distinguished.

Optionally, the operation of determining at least one candidate parameter which fails to meet the reduction condition, and obtaining the test result respectively corresponding to the at least one candidate parameter may include: obtaining the test result information respectively corresponding to the plurality of candidate parameters, determining the at least one candidate parameter with the test state information being completed in the test result information respectively corresponding to the plurality of candidate parameters, and obtaining the test result in the test result information corresponding to the at least one candidate parameter.

The test result may be a use effect value obtained by performing parameter estimation on the candidate parameter in the parameter test. The test result is better if the use effect value is higher. The test result is poorer if the use effect value is lower. The operation of selecting the target parameter meeting the parameter optimization condition from the at least one candidate parameter may include: selecting the candidate parameter with the greatest use effect corresponding to the test result from the test result respectively corresponding to the at least one candidate parameter to be used as the target parameter meeting the parameter optimization condition.

The parameter optimization problem may be directly involved in various application fields. In order to improve the parameter optimization effect, the technical solution of the embodiments of the present disclosure may be used.

In an allocation process of electricity resources and water resources, the allocation result of the electricity resources or water resources in each region may be used as a to-be-processed parameter to initiate a parameter optimization request. The to-be-processed parameter specifically may be the resource quantity corresponding to each region, and for example, may be the load capacity of the region in an electric power scene.

As an embodiment, before determining a target function corresponding to a parameter optimization request in response to the parameter optimization request, the method may further include: receiving a parameter optimization request initiated for a to-be-processed parameter of a target resource. The operation of determining a target function corresponding to a parameter optimization request in response to the parameter optimization request includes: determining a target function corresponding to a processing target of the target resource in response to the parameter optimization request.

The method further includes: performing sampling processing on the to-be-processed parameter for multiple times to obtain a plurality of candidate parameters.

After the operation of according to the test result respectively corresponding to the at least one candidate parameter, selecting the target parameter meeting the optimal parameter condition from the at least one candidate parameter, the method further includes: according to a value of the to-be-processed parameter at the target parameter, generating processing information of the target resource to process the target resource according to the processing information.

The resource element specifically represented by the to-be-processed parameter may be determined according to the processing target of the target resource. For example, when the processing target of the target resource is the electricity load capacity set for different regions so that the total energy consumption of an electric network is optimum, at this moment, the electricity load capacity of different regions may be the to-be-processed parameter, and the processing target may be the computing function of the total energy consumption of the electric network. The target parameter may be the electricity load capacity of each region under the condition of the optimum obtained total energy consumption of the electric network. According to the value of the to-be-processed parameter at the target parameter, the processing information of the target resource may be generated. That is, the prompt information or configuration instructions for the electricity load capacity of each region may be generated according to the value of the to-be-processed parameter at the target parameter, and through the configuration instructions, the capacity may be set according to the electricity load capacity of each region. The prompt information may be shown to the user so that the user may set the capacity for each region according to the electricity load capacity of each region shown in the prompt information.

In the field of electronic commerce, the parameter optimization problem may also be involved. By taking the common product recommendation as an example, contents or products recommended to the users are different since the browsing features, such as consumption habits, interested fields and historical browsing behaviors, of the users are different. In practical applications, in order to improve the user’s click rate, the browsing features such as the consumption habits and the interested field of the user may be parameterized, to generate different browsing parameters. The feature of click targets of the user can be accurately analyzed through setting a plurality of browsing parameters, so that the target product with higher user attention can be found. The solution of performing parameter sampling to the plurality of browsing parameters and performing the parameter test to determine that the click probability of the user may apply the technical solution of the embodiments of the present disclosure to improve the test efficiency.

Therefore, as an embodiment, before determining a target function corresponding to a parameter optimization request in response to the parameter optimization request, the method may include: detecting a browsing operation initiated by the target user, and generating a parameter optimization request for a browsing parameter of the target user.

The operation of determining the target function corresponding to a parameter optimization request in response to the parameter optimization request includes: determining the target function corresponding to the visit target of the target user in response to the parameter optimization request.

The method further includes performing sampling processing on the browsing parameter for multiple times to obtain a plurality of candidate parameters.

After the operation of according to the test result respectively corresponding to the at least one candidate parameter, selecting the target parameter meeting the optimal parameter condition from the at least one candidate parameter, the method further includes: according to a value of the browsing parameter at the target parameter, generating visit recommendation information of the target user; and searching a target product matched with the visit recommendation information from a product database so as to output the target product to the target user.

By setting corresponding browsing parameters for the browsing feature of the target user, the corresponding browsing parameters are obtained, so that the browsing parameters are subjected to the parameter test to obtain the optimum target parameter. Of course, in practical applications, the browsing parameters include one or more sub parameters, and a candidate parameter may be formed after the sampling of the parameter values respectively corresponding to the plurality of sub parameters is completed. After the target parameter is determined, the visit recommendation information of the target user is determined, so that the target product matched with the visit recommendation information may be searched to be output for the target user.

In some embodiments, the browsing parameters may be the proportions of different browsing features, and the proportions of different browsing features in the product searching process may be determined according to the value of the browsing parameters at the target parameter, so that a weighted sum can be calculated according to the respective values of the plurality of browsing features at the target parameter, to obtain the recommendation feature. The recommendation feature may be the visit recommendation information.

In some other embodiments, the browsing parameters may be proportions of different types of products. That is, products may be respectively recommended for the user from a plurality of types of products. However, the proportions of the products of each type are different. Taking beauty makeup products and clothes products being major recommendation types as an example, the respective recommendation proportions of the beauty makeup products and clothes products are subjected to parameter optimization, and the finalized target parameter is 3:7 while the proportion of the beauty makeup products is 3/10 and the proportion of the clothes products is 7/10. At this moment, according to the value of the browsing parameters at the target parameter, the generated visit recommendation information may be specifically searching beauty makeup products and clothes products according to a ratio of 3:7. At this moment, 3 parts of beauty makeup products and 7 parts of clothes products matched with the recommendation information are searched from the product database, and are output to the user.

It is noted that the specific application solutions of the parameter optimization shown in the present disclosure are only illustrative, and do not constitute the application limitation to the embodiments of the present disclosure. The embodiments of the present disclosure may be applicable to the parameter optimization scenes of various data models and computing models.

In a possible design, the technical solution of the embodiments of the present disclosure may be configured in a server to provide parameter optimization service to external parties. As shown in FIG. 6, it is a flowchart of a data processing method according to some other embodiments of the present disclosure. The method may include the following steps 601, 602, 603, 604, and 605.

In step 601, a processing resource corresponding to a parameter processing interface is determined in response to a request of calling the parameter processing interface.

The following steps 602, 603, 604, and 605 are executed by using the processing resource corresponding to the parameter processing interface.

In step 602, a target function corresponding to a parameter optimization request is determined in response to the parameter optimization request.

Before determining a target function corresponding to a parameter optimization request in response to the parameter optimization request, the operation further includes: obtaining the parameter optimization request.

In step 603, in a process of performing a parameter test on any candidate parameter by the target function, a test reduction module is called to determine whether the parameter test meets a reduction condition or not to obtain a determination result.

In step 604, in response to the determination result being that the parameter test meets the reduction condition, the parameter test of the candidate parameter is stopped.

In step 605, in response to the determination result being that the parameter test fails to meet the reduction condition, the parameter test of the candidate parameter continues to be executed to obtain the test result of the candidate parameter.

In a possible design, the following processing steps may be executed by using the processing resource corresponding to the parameter processing interface: determining at least one candidate parameter which fails to meet the reduction condition, and obtaining the test result respectively corresponding to the at least one candidate parameter; and according to the test result respectively corresponding to the at least one candidate parameter, selecting the target parameter meeting the optimal parameter condition from the at least one candidate parameter.

In a possible design, the following processing steps may be executed by using the processing resource corresponding to the parameter processing interface: obtaining the plurality of test reduction algorithms in response to the request of calling the test reduction interface; determining the target reduction algorithm matched with the parameter test from the plurality of test reduction algorithms; and determining whether the intermediate test result of the candidate parameter meets the reduction condition or not by determining whether the intermediate test result meets the reduction condition or not according to the target reduction algorithm.

In further another possible design, the test reduction module includes a plurality of test reduction algorithms. The target reduction algorithm is determined from the plurality of test reduction algorithms by: searching the target reduction algorithm matched with the parameter test from the plurality of test reduction algorithms of the test reduction module.

The specific steps executed by the processing resource corresponding to the parameter processing interface in the embodiments of the present disclosure is the same as the processing steps executed by the data processing method as shown in FIG. 1 to FIG. 5. The specific implementation and technical effects of each technical feature have been described in detail in the above embodiments as shown in FIG. 1 to FIG. 5, and are not repeated herein.

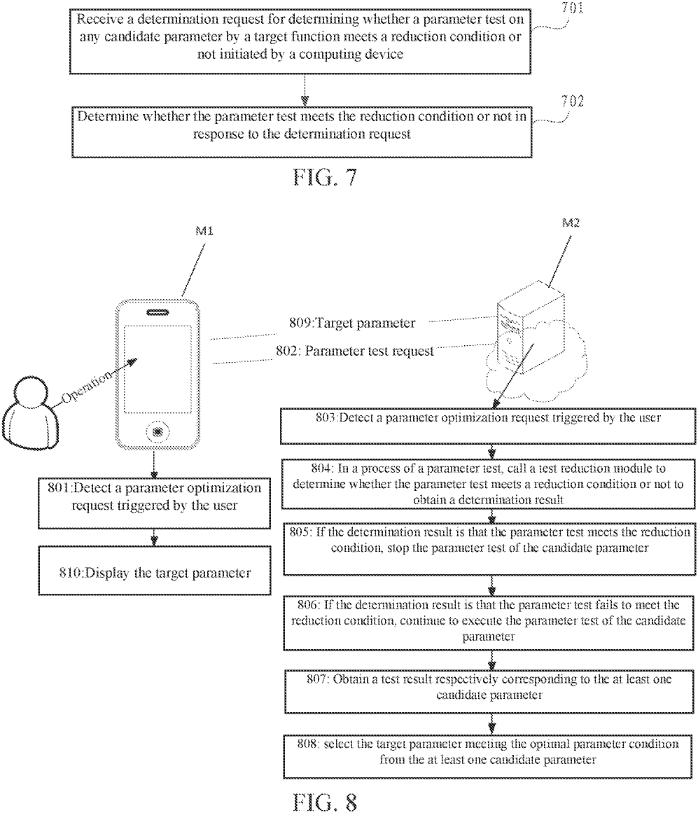

As shown in FIG. 7, it is a flowchart of a data processing method according to some other embodiments of the present disclosure. The method may include the following steps 701 and 702.

In step 701, a determination request for determining whether a parameter test on a candidate parameter by a target function meets a reduction condition or not initiated by a computing device is received.

The target function is determined by the computing device in response to the parameter optimization request.

In step 702, whether the parameter test meets the reduction condition or not is determined in response to the determination request.

The parameter test of the candidate parameter is stopped when the reduction condition is met. The parameter test of the candidate parameter continues to be executed when the reduction condition fails to be met so as to obtain a test result of the candidate parameter.

In the embodiments of the present disclosure, when a determination request for determining whether a parameter test of a target function on the candidate parameter meets a reduction condition or not initiated by a computing device is received, whether the parameter test meets the reduction condition or not may be determined in response to the determination request. By determining whether the parameter test meets the reduction condition or not, the parameter test may be accurately monitored to improve the parameter test accuracy.

As an embodiment, whether the parameter test meets the reduction condition or not may be specifically determined in the following manner: determining the target reduction algorithm matched with the parameter test from the plurality of test reduction algorithms; and determining whether the parameter test meets the reduction condition or not according to the target reduction algorithm to generate a determination result.

In some embodiments, the target reduction algorithm is determined from the plurality of test reduction algorithms by searching the target reduction algorithm matched with the parameter test from the plurality of test reduction algorithms of the test reduction module.

As another possible implementation, the operation of determining whether the parameter test meets the reduction condition or not according to the target reduction algorithm to generate the determination result may include: based on the target reduction algorithm, determining whether the intermediate test result of the parameter test meets the reduction condition or not to generate the determination result.

Optionally, the method also includes: receiving a determination request for determining whether a parameter test of the target function on the candidate parameter meets the reduction condition or not, in which the target function is determined by the computing device in response to a parameter optimization request; determining whether the parameter test meets the reduction condition or not in response to the determination request to generate the determination result, in which the determination result includes that the parameter test meets the reduction condition or that the parameter test fails to meet the reduction condition, the parameter test of the candidate parameter is stopped when the reduction condition is met, and the parameter test of the candidate parameter continues to be executed when the reduction condition is not met so as to obtain the test result of the candidate parameter.

Optionally, the operation of determining whether the parameter test meets the reduction condition or not in response to the determination request may include: obtaining the target reduction algorithm provided by the computing device in response to the determination request, and determining whether the parameter test meets the reduction condition or not based on the target reduction algorithm.

Optionally, the operation of determining whether the parameter test meets the reduction condition or not in response to the determination request may include: searching the target reduction algorithm matched with the parameter test from the plurality of test reduction algorithms of the test reduction module in response to the determination request, and determining whether the parameter test meets the reduction condition or not based on the target reduction algorithm.

Optionally, the operation further includes: obtaining the intermediate test result of the candidate parameter in response to the determination request, and determining whether the intermediate test result meets the reduction condition or not. The operation of determining whether the intermediate test result meets the reduction condition or not includes: determining the target reduction algorithm matched with the parameter test in the plurality of test reduction algorithms, and determining whether the intermediate test result meets the reduction condition or not according to the target reduction algorithm to generate the determination result.

Parts of steps in the embodiments as shown in FIG. 7 are the same as parts of steps in the embodiments as shown in FIG. 1, etc., so that the specific implementation and technical effects of each step are not repeated herein for the description simplicity.

For the ease of understanding, an application example of the embodiments of the present disclosure will be illustrated in detail by taking a hyperparameter formed by the network depth, the number of iterations, the number of neurons per layer of the machine learning model as the to-be-optimized parameter and taking the data processing method provided by the cloud server performing interaction with a user device as an example.

Referring to FIG. 8, in practical applications, the user device, for example, may be terminal devices such as a mobile terminal or an Internet of Things (IoT) terminal, and may interact with the user. The user device can communicate with a server capable of optimizing the hyperparameter. For example, the user device may be a mobile terminal M1 and the server may be a cloud server M2. The mobile terminal M1 may perform operation 801 to detect a parameter optimization request triggered by the user, for instance, to optimize the hyperparameter formed by the network depth, the number of iterations, and the number of neurons per layer of the machine learning model. In operation 802, the mobile terminal M1 may send the parameter optimization request to the server M2. In operation 803, the cloud server M2 may determine the target function in response to the parameter optimization request.

Then, in operation 804, in a process of performing a parameter test on any candidate parameter by the target function, the cloud server M2 may call a test reduction module to determine whether the parameter test meets a reduction condition or not to obtain the determination result. In operation 805, in response to the determination result being that the parameter test meets the reduction condition, the parameter test of the candidate parameter is stopped. In operation 806, in response to the determination result being that the parameter test fails to meet the reduction condition, the parameter test of the candidate parameter continues to be executed to obtain the test result of the candidate parameter. The time loss of the parameter test may be reduced by performing interruption determination on the parameter test of the candidate parameter.

In some embodiments, in operation 807, the cloud server M2 may further determine at least one candidate parameter which fails to meet the reduction condition, and obtain the test result respectively corresponding to the at least one candidate parameter. In operation 808, according to the test result respectively corresponding to the at least one candidate parameter, the target parameter meeting the optimal parameter condition is selected from the at least one candidate parameter.

In operation 809, if the cloud server M2 executes the selection of the target parameter meeting the optimal parameter condition, the target parameter obtained through the final selection may be sent to the mobile terminal M1. In operation 810, after the mobile terminal M1 receives the target parameter, the mobile terminal M1 may display and output the target parameter. The target parameter may be output in various forms, such as data, pages, information or messages, etc. The specific output manner of the target parameter is not limited in the embodiments of the present disclosure.

In practical applications, the target parameter obtained by the parameter optimization methods provided by the embodiments of the present disclosure may be directly applied to a model training scene of a machine learning model. For example, when the parameter optimized by the user is the hyperparameter, the obtained optimum target parameter is the target hyperparameter. The machine learning model may be built by using the target hyperparameter, the training data is used to train the machine learning model to obtain the model parameter of the machine learning model built by using the target hyperparameter. The obtained machine learning model has a better use effect. For example, in the field of face recognition, the recognition accuracy of the face recognition model formed by the optimum hyperparameter is higher.

The technical solution of the embodiments of the present disclosure may be applied to various fields of artificial intelligence interaction, data search, content recommendation, click rate prediction, intelligent factory, industrial control, etc., and particularly has great applicability in the field of content recommendation, such as the content recommendation in the fields of electronic commerce, live video, social interaction and online education and in the fields of resource allocation such as financial product allocation, electricity resources, water resources and supply chain allocation.

For the ease of understanding, the embodiments of the present disclosure are described in detail by taking the problem cases in the following practical field scenes as examples.

First, in the electronic commerce field, the application scenes of feature searching, product recommendation in the live video scene, content recommendation, advertisement click rate calculation, and the like in the electronic commerce field are most common. In the embodiments of the present disclosure, taking the content recommendation scene as an example, an example deployment may be performed. A common recommendation process in a recommendation scene may be performing a parameterization configuration on elements of the selected scene to obtain a plurality of parameters having influence on the scene, marking different features of the scene by using the plurality of parameters and performing feature assignment on the plurality of parameters to obtain a candidate parameter. Based on the specific application requirements of the scene, the target function matched with the scene is selected, and the candidate parameter is input into the target function for the parameter test when the user initiates the parameter optimization request of the candidate parameter. In a process of performing a parameter test on any candidate parameter by the target function, the test reduction module is called to determine whether the parameter test meets a reduction condition or not to obtain a determination result. If the determination result is that the parameter test meets the reduction condition, the parameter test of the candidate parameter is stopped. If the determination result is that the parameter test fails to meet the reduction condition, the parameter test of the candidate parameter continues to be executed to obtain the test result of the candidate parameter.

Taking a click word recommendation scene as an example, when the user clicks a query box in an application, the system may recommend parts of query words for the user. The purpose of recommending the query words for the user is to mine the potential purchasing requirements of the user, increase the customer stickiness of the user and improve the total commodity trading volume. In a query system, the following architecture is used, to combine a deep learning Encode-Decode network, i.e., the target network, to predict the recommendation of the query words. It is supposed that the quantity of the query words is subjected to the optimum parameter selection. In the conventional systems, the optimum parameter value of the parameter formed by the quantity of the query words is manually set according to human experiences. By using the data processing methods provided in the present disclosure, the parameter test can be automatically performed to the quantity of the query words according to the above parameter optimization process. Then, the at least one quantity of the query words meeting the reduction condition is obtained, and the test result respectively corresponding to the at least one quantity of the query words is obtained. According to the test result respectively corresponding to the at least one quantity of the query words, the target quantity of the query words meeting the optimal parameter condition is selected from the at least one quantity of the query words. The obtained quantity of target query words may be used as the optimum quantity of the query words. By performing the interruption monitoring on the parameter test of the quantity of query words, the invalid test on the current quantity of query words may be avoided, and the optimization efficiency of the quantity of query words is improved.

In the social interaction field, the content recommendation to social users and material recommendation to students are very common. The recommendation in the social interaction field is generally that social users browse social applications, and social interaction contents interested by the users are shown in display interfaces of the applications. Generally, for the recommendation in the social interaction field, options including the user’s historical browsing behaviors, interested fields, user information, etc., form feature parameters. Combinations of different options may form different parameters. When the parameters are determined, the feature information may be generated. Contents related to the feature information are searched based on the feature information concerned by the user. The searching for the contents related to the feature information may be used as a target function. In order to find the contents interested by the social user, the quantity and the type of the parameters may be optimized to obtain the accurate social user contents.

The technical solution of the embodiments of the present disclosure may be configured in a cloud server. The parameter optimization request may be initiated by the operation and maintenance staff. The operation and maintenance staff may set the plurality of parameters and the plurality of parameters formed by the user related information. Then, the candidate parameters are generated continuously. Next, the parameter test is performed to each of the candidate parameters. In a process of performing the parameter test on any candidate parameter by the target function, the test reduction module is called to determine whether the parameter test meets a reduction condition or not to obtain a determination result. For example, the searching quantity of the parameter test may be monitored. When 1000 contents are searched, if the quantity of the contents reaching more than 60% similarity to the current set feature information exceeds a preset quantity threshold, it may be determined that the parameter test fails to meet the reduction condition. If the quantity does not exceed the preset quantity threshold, it may be determined that the parameter test meets the reduction condition.

If the determination result is that the parameter test meets the reduction condition, the parameter test of the candidate parameter is stopped. If the determination result is that the parameter test does not meet the reduction condition, the parameter test of the candidate parameter continues to be executed to obtain the test result of the candidate parameter. Through the parameter test reduction by using the test reduction module, the parameter test efficiency may be improved, to further ensure that the optimum feature option of the user can be promptly obtained.

In the financial field, the stock index simulation is a very important problem. The stock index simulation problems based on models such as linear regression, support vector machines (SVM), long short-term memory (LSTM), etc., are common. It is needed to build a proper model first before using the model. In a model training process, various hyperparameters may be involved, for example, time step length (time_step), feature dimension (feature_dim), hidden feature, and the like in the LSTM. Additionally, contextual features such as macro and micro factors, and incidents of the market, etc., are also involved. These contextual features may influence the parameter selection. By using the technology of the present disclosure, after the parameter value configuration is performed to each parameter for multiple times, the candidate parameter formed by the parameter value of each parameter may be obtained. The parameter test is performed to each candidate parameter, so that the optimum target parameter may be selected from the candidate parameters.

In order to improve the efficiency of the parameter optimization to the candidate parameters above, the target function may be used for performing the parameter test on the candidate parameter formed after obtaining the values of the hyperparameters. In a process of performing the parameter test on the candidate parameter by the target function, the test reduction module is called to determine whether the parameter test meets the reduction condition or not to obtain the determination result. If the determination result is that the parameter test meets the reduction condition, the parameter test of the candidate parameter is stopped. If the determination result is that the parameter test fails to meet the reduction condition, the parameter test of the candidate parameter continues to be executed to obtain the test result of the candidate parameter. At least one candidate parameter meeting the reduction condition is obtained, and the test result respectively corresponding to the at least one candidate parameter is obtained. According to the test result respectively corresponding to the at least one candidate parameter, the target parameter meeting the optimal parameter condition is selected from the at least one candidate parameter. By using the obtained target parameter, the machine learning model corresponding to the index simulation problem may be built. The model training is performed to obtain the model parameter. Then, the machine learning model obtained through the training is used to perform simulation computation on data such as the root mean squared error (RMSE) difference value of an actual stock index for the index simulation problem.

In the resource allocation field, the allocation of the electricity resource is taken as an example. The allocation of the electricity resource may generally involve various regions. Each region may be represented by a corresponding parameter. These parameters may respectively allocate a certain proportion of resources, and the resource allocation may influence information such as region economy, population and environment.

The technical solution of the embodiments of the present disclosure may be applied to the problem of the dynamic pricing in the electricity market and the economic load distribution of the electricity. The specific application fields of the electric power system will be mainly illustrated in detail hereafter.

For the problem of the dynamic pricing in the electricity market, the user type and the electricity consumption have key influence on the electricity market. Parameters such as the user type and the electricity consumption may be used as to-be-optimized parameters, and the parameters are sampled to obtain candidate parameters. The earning/cost of the electric power system through the configurations of the candidate parameters may be the final optimization target to determine the target function corresponding to the optimization target. The parameter test is performed to the candidate parameter by using the target function to obtain a target value of the system earning/cost. The optimum target value is obtained by continuously performing the parameter test of the candidate parameters. In the parameter test process, the technical solution of the embodiments of the present disclosure may be used for test reduction on the candidate parameter to reduce the parameter test of the candidate parameter with poor estimation result and to improve the parameter optimization efficiency.

For the problem of the economic load distribution of the electricity, an electricity supplier may provide electricity resources for a plurality of regions. The electricity load capacity of each region may be used as a candidate parameter, and the total energy consumption on the electricity grid may be used as an output of the target function. By using the technical solution of the embodiments of the present disclosure, the respective electricity load capacity of a plurality of regions may be set to obtain a candidate parameter. The parameter test is performed to the candidate parameter by the target function to obtain the computing result of the candidate parameter. The target function may be a nonlinear constraint relationship between the electricity load capacity and the total energy consumption on the electricity grid. The target function may be expressed in a black box optimization algorithm form, to obtain the target function of the black box. Then, the parameter test is continuously performed on the electricity load capacity of each region to obtain the optimum load capacity distribution strategies. During the parameter test on the electricity load capacity of each region, the technical solution of the embodiments of the present disclosure may be used to perform the test reduction to the parameter test to reduce the parameter test of the candidate parameter with poor estimation result and to improve the parameter optimization efficiency.

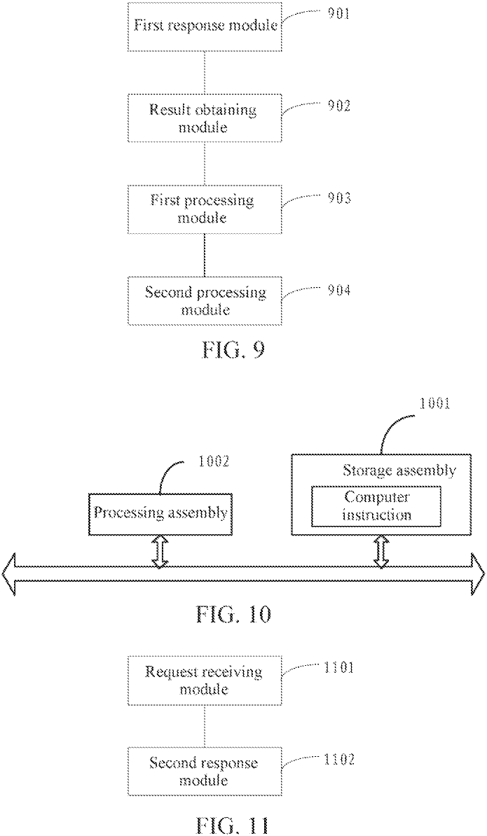

As shown in FIG. 9, it is a schematic structural diagram of a data processing device, according to some embodiments of the present disclosure. The device may include a first response module 901, a result obtaining module 902, a first processing module 903, and a second processing module 904.

The first response module 901 is configured to determine a target function corresponding to a parameter optimization request in response to the parameter optimization request.

The result obtaining module 902 is configured to call a test reduction module in a process of performing a parameter test on any candidate parameter by the target function to determine whether the parameter test meets a reduction condition or not to obtain a determination result.

The first processing module 903 is configured to stop the parameter test of the candidate parameter when the determination result is that the parameter test meets the reduction condition.

The second processing module 904 is configured to continue to execute the parameter test of the candidate parameter to obtain the test result of the candidate parameter when the determination result is that the parameter test fails to meet the reduction condition.

In the embodiments of the present disclosure, after the target function corresponding to the parameter optimization request of the candidate parameter is determined in response to the parameter optimization request, in a process of performing a parameter test on any candidate parameter by the target function, a test reduction module may be called to determine whether a parameter test meets a reduction condition or not to obtain a determination result. If the determination result of the candidate parameter is that the candidate parameter meets the reduction condition, the parameter test of the candidate parameter is stopped. If the determination result is that the parameter test fails to meet the reduction condition, the parameter test of the candidate parameter may continue to be executed to obtain the test result corresponding to the candidate parameter. The parameter test of the candidate parameter is monitored to confirm whether the candidate parameter needs to completely execute the whole parameter test or not so as to improve the test efficiency of the candidate parameter, reduce the unnecessary candidate parameter test process, and improve the parameter optimization efficiency.

As an example, the test reduction module includes a plurality of test reduction algorithms.

The result obtaining module may include a result obtaining unit.

The device may further include a result obtaining unit configured to call the target reduction algorithm in the plurality of test reduction algorithms of the test reduction module to determine whether the parameter test meets a reduction condition or not in a process of performing a parameter test on any candidate parameter by the target function to obtain a determination result.

In some embodiments, the device further includes an algorithm matching module configured to search the target reduction algorithm matched with the parameter test from the plurality of test reduction algorithms of the test reduction module.

As a possible implementation, the algorithm matching module may include a first determining unit configured to determine first test information corresponding to the parameter test of the candidate parameter, a first obtaining unit configured to obtain second test information respectively associated with the plurality of test reduction algorithms, an information matching unit, configured to search target test information matched with the first test information from the second test information respectively corresponding to the plurality of test reduction algorithms, and an algorithm determination unit configured to determine the test reduction algorithm corresponding to the target test information as the target reduction algorithm.

As a possible implementation, the first test information includes a parameter test type.

The information matching unit may include a first searching sub-unit configured to search the target test information matched with the parameter test type of the first test information from the second test information respectively corresponding to the plurality of test reduction algorithms.

In a possible design, the parameter test type includes a serial test type and a parallel test type.

The first searching sub-unit may be specifically configured to: in response to the parameter test type of the candidate parameter being the serial test type, determine the target test information with the serial test type from the second test information respectively corresponding to the plurality of test reduction algorithms; or in response to the parameter test type of the candidate parameter being the parallel test type, determine the target test information with the parallel test type from the second test information respectively corresponding to the plurality of test reduction algorithms.

As another possible implementation, the first test information includes: a parameter test stage.

The information matching unit may include a second searching sub-unit configured to search the target test information matched with the parameter test stage of the first test information from the second test information respectively corresponding to the plurality of test reduction algorithms.

In a possible design, the parameter test stage includes: a phase I stage test period, a phase II stage test period, and a phase III stage test period.

The second searching sub-unit may be specifically configured to: in response to the parameter test stage of the candidate parameter being the phase I stage test period, determine the target test information with the phase I stage test period from the second test information respectively corresponding to the plurality of test reduction algorithms; or in response to the parameter test stage of the candidate parameter being the phase II stage test period, determine the target test information with the phase II stage test period from the second test information respectively corresponding to the plurality of test reduction algorithms; or in response to the parameter test stage of the candidate parameter being the phase III stage test period, determine the target test information with the phase III stage test period from the second test information respectively corresponding to the plurality of test reduction algorithms.

As another possible implementation, the first test information may further include a parameter test stage and a parameter test type.

The information matching unit may include a third searching sub-unit configured to determine target test information matched with the parameter test type and the parameter test stage at the same time from the second test information respectively corresponding to the plurality of test reduction algorithms.

In some embodiments, the result obtaining module may include: a second obtaining unit configured to call a test reduction module in a process of performing a parameter test on any candidate parameter by the target function to determine whether an intermediate test result of the parameter test meets a reduction condition or not to obtain a determination result.

The second obtaining unit may be further specifically configured to call the target reduction algorithm in the plurality of test reduction algorithms of the test reduction module to determine whether an intermediate test result of the parameter test meets a reduction condition or not in a process of performing a parameter test on any candidate parameter by the target function to obtain a determination result.

The target reduction algorithm includes a historical estimation algorithm.

The second obtaining unit may include a result estimation sub-unit configured to estimate an estimated test result corresponding to the intermediate test result according to historical intermediate results and historical test results respectively corresponding to a plurality of historical parameters, and a first determination sub-unit configured to determine whether the estimated test result is matched with a result threshold or not. If not, it is determined that the intermediate test result meets the reduction condition. If so, it is determined that the intermediate test result fails to meet the reduction condition.

In some embodiments, the target reduction algorithm includes a computational comparison algorithm.

The second obtaining unit may include a reference obtaining sub-unit configured to determine an intermediate reference value corresponding to a monitoring node for obtaining the intermediate test result in the parameter test process, and a second determination sub-unit configured to determine whether the intermediate reference value meets a preset reference threshold or not. If not, it is determined that the intermediate test result meets the reduction condition. If so, it is determined that the intermediate test result fails to meet the reduction condition.

In a possible design, the plurality of test reduction algorithms include a self-defined reduction algorithm set by a target user.

The algorithm matching module may include an algorithm matching unit configured to determine the self-defined reduction algorithm as the target reduction algorithm if the self-defined reduction algorithm set by a target user exists in the plurality of test reduction algorithms.

The device may further include: an algorithm storage module configured to control the test reduction module to store the self-defined reduction algorithm based on the self-defined reduction algorithm set by the target user.

Optionally, the algorithm matching module may specifically include a prompt generation sub-unit configured to generate prompt information showing the existence of the self-defined reduction algorithm if the self-defined reduction algorithm set by a target user exists in the plurality of test reduction algorithms, and an algorithm showing sub-unit configured to show the prompt information to the target user for the target user to confirm whether the self-defined algorithm is applicable to the parameter test or not, and an algorithm determination sub-unit configured to determine the self-defined reduction algorithm as the target reduction algorithm if the target user executes a confirming operation for the self-defined reduction algorithm applicable to the parameter test.

As further another embodiment, the device further includes: a parameter determination module configured to determine at least one candidate parameter which fails to meet the reduction condition in the plurality of candidate parameters, and obtain the test result respectively corresponding to the at least one candidate parameter, and a parameter selecting module configured to select the target parameter meeting the optimal parameter condition from the at least one candidate parameter according to the test result respectively corresponding to the at least one candidate parameter.

In some embodiments, the device may further include a resource request module configured to receive a parameter optimization request initiated for a to-be-processed parameter of a target resource.

The first response module may include a first response unit configured to determine a target function corresponding to a processing target of the target resource in response to the parameter optimization request.

The device may further include a first sampling module configured to perform sampling processing on the to-be-processed parameter for multiple times to obtain a plurality of candidate parameters, and a resource processing module configured to generate processing information of the target resource according to a value of the to-be-processed parameter at the target parameter to process the target resource according to the processing information.

In some other embodiments, the device may further include a browsing response module configured to detect a browsing operation initiated by the target user, and generate a parameter optimization request for a browsing parameter of the target user.

The first response module may include a second response unit configured to determine a target function corresponding to a visit target of the target user in response to the parameter optimization request.

The device may further include a second sampling module configured to perform sampling processing on the browsing parameter for multiple times to obtain a plurality of candidate parameters, an information generation module configured to generate visit recommendation information of the target user according to a value of the browsing parameter at the target parameter, and a product matching module configured to search a target product matched with the visit recommendation information from a product database so as to output the target product to the target user.

The data processing device as shown in FIG. 9 may execute the data processing method of the embodiments shown in FIG. 1, so its implementation principle and technical effects are not repeated herein. The specific implementations of each step executed by processing assemblies in the embodiments have been described in detail in the embodiments associated with the method, and will not be described in detail herein.

In practical applications, a data processing device shown in FIG. 10 may be a computing device. Referring to FIG. 10, it is a schematic structural diagram of a computing device according to some embodiments of the present disclosure. The device may include a storage assembly 1001 and a processing assembly 1002. The storage assembly 1001 is configured to store one or more computer instructions. The one or more computer instructions are called by the processing assembly 1002 to execute a hyperparameter optimization method according to the embodiments shown in FIG. 1, etc.

The processing assembly 1002 may include one or more processors to execute computer instructions to complete all or parts of the steps of the above methods. Of course, the processing assembly may be one or more application-specific integrated circuits (ASICs), digital signal processors (DSPs), digital signal processing devices (DSPDs), programmable logic devices (PLDs), field-programmable gate arrays (FPGAs), controllers, micro controllers, microprocessors or other electronic elements, and are configured to execute the above methods.

The storage assembly 1001 is configured to store various types of data to support operations at a terminal. The storage assembly may be realized by any type of volatile or non-volatile storage devices or a combination thereof, such as a static random access memory (SRAM), an electrically erasable programmable read-only memory (EEPROM), an erasable programmable read-only memory (EPROM), a programmable read only memory (PROM), a read-only memory (ROM), a magnetic memory, a flash memory, a magnetic disk or a compact disc.

Of course, the computing device may include other components, such as an input/output interface, a communication assembly, etc. The input/output interface is an interface provided between the processing assembly and a peripheral interface module. The peripheral interface module may be an output device, an input device, etc. The communication assembly is configured to facilitate wired or wireless communication, etc., between the computing device and other devices.

Additionally, in the embodiments of the present disclosure, a computer readable storage medium is also provided. The storage medium may store one or more computer instructions. When being executed, the one or more computer instructions are configured to realize any data processing method in the embodiments of the present disclosure.

As shown in FIG. 11, it is a schematic structural diagram of a test reduction device according to some other embodiments of the present disclosure. The device may include a request receiving module 1101 and a second response module 1102.

The request receiving module 1101 is configured to receive a determination request for determining whether a parameter test of a target function on any candidate parameter meets a reduction condition or not initiated by a computing device.

The target function is determined by the computing device in response to a parameter optimization request.

The second response module 1102 is configured to determine whether the parameter test meets the reduction condition or not in response to the determination request.

The parameter test of the candidate parameter is stopped when the reduction condition is met, and the parameter test of the candidate parameter continues to be executed when the reduction condition fails to be met so as to obtain a test result of the candidate parameter.

In some embodiments, the device further includes: a second determination module configured to determine the target reduction algorithm matched with the parameter test from the plurality of test reduction algorithms, and a third determination module configured to determine whether the parameter test meets the reduction condition or not according to the target reduction algorithm to generate a determination result.

Optionally, the target reduction algorithm is determined from the plurality of test reduction algorithms by: searching the target reduction algorithm matched with the parameter test from the plurality of test reduction algorithms of the test reduction module.

In some embodiments, the third determination module may be specifically configured to determine whether the intermediate test result of the parameter test meets the reduction condition or not according to the target reduction algorithm to generate a determination result.

The test reduction device shown in FIG. 11 may execute the data processing method of the embodiments shown in FIG. 7, so its implementation principle and technical effects are not repeated herein. The specific implementations of each step executed by processing assemblies in the embodiments have been described in detail in the embodiments associated with the methods, and will not be described in detail herein.

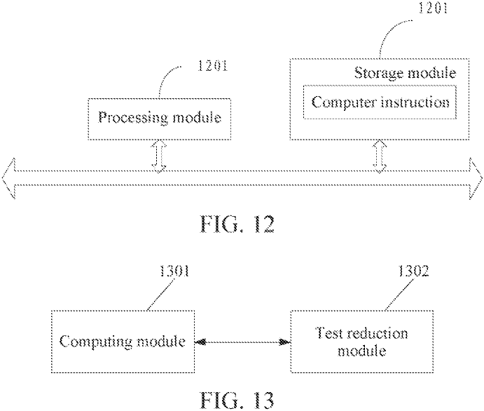

In practical applications, the test reduction device shown in FIG. 11 may be a test reduction equipment. Referring to FIG. 12, it is a schematic structural diagram of a test reduction equipment according to some embodiments of the present disclosure. The equipment may include: a storage assembly 1201 and a processing assembly 1202. The storage assembly 1201 is configured to store one or more computer instructions. The one or more computer instructions are called by the processing assembly 1202 to execute a data processing method according to embodiments shown in FIG. 7, etc.

The processing assembly 1202 may include one or more processors to execute computer instructions to complete all or parts of the steps of the above methods. Of course, the processing assembly may be one or more application-specific integrated circuits (ASICs), digital signal processors (DSPs), digital signal processing devices (DSPDs), programmable logic devices (PLDs), field-programmable gate arrays (FPGAs), controllers, micro controllers, microprocessors or other electronic elements, and are configured to execute the above methods.

The storage assembly 1201 is configured to store various types of data to support operations at a terminal. The storage assembly may be realized by any type of volatile or non-volatile storage devices or a combination thereof, such as a static random access memory (SRAM), an electrically erasable programmable read-only memory (EEPROM), an erasable programmable read-only memory (EPROM), a programmable read only memory (PROM), a read-only memory (ROM), a magnetic memory, a flash memory, a magnetic disk or a compact disc.

Of course, the computing device may include other components, such as an input/output interface, a communication assembly, etc. The input/output interface is an interface provided between the processing assembly and a peripheral interface module. The peripheral interface module may be an output device, an input device, etc. The communication assembly is configured to facilitate wired or wireless communication, etc. between the computing device and other devices.

Additionally, in the embodiments of the present disclosure, a computer readable storage medium is also provided. The storage medium may store one or more computer instructions. When being executed, the one or more computer instructions are configured to realize any data processing method in the embodiments of the present disclosure.

As shown in FIG. 13, it is a schematic structural diagram of a data processing system according to some other embodiments of the present disclosure. The system may include a computing module 1301 and a test reduction module 1302.

The computing module is configured to determine a target function corresponding to a parameter optimization request in response to the parameter optimization request, to generate, in a process of performing a parameter test on any candidate parameter by the target function, a determination request to determine whether the parameter test meets a reduction condition or not, to send the determination request to the test reduction module, to determine a determination result corresponding to the determination request, to stop the parameter test of the candidate parameter in response to the determination result being that the parameter test meets the reduction condition, and to continue to execute the parameter test of the candidate parameter to obtain the test result of the candidate parameter, in response to the determination result being that the parameter test does not meet the reduction condition.

The test reduction module is configured to obtain the determination request sent by the computing module and determine whether the parameter test meets the reduction condition or not in response to the determination request.

In some embodiments, the operation that the computing module generates the determination request to determine whether the parameter test meets a reduction condition or not in a process of performing a parameter test on any candidate parameter by the target function specifically includes: in a process of performing a parameter test on any candidate parameter by the target function, generating the determination request to determine whether the parameter test meets a reduction condition or not based on the target reduction algorithm in the plurality of test reduction algorithms of the test reduction module.

The computing module in the embodiments of the present disclosure may be the computing device in the above embodiments. The test reduction module may be the test reduction device in the above embodiments. The specific contents executed by the computing module and the test reduction module and the technical effects have been described in detail in the above embodiments, and are not repeated herein.

The device embodiments described above are only illustrative, the unit illustrated as a separate component may or may not be physically separated, and a component shown as a unit may or may not be a physical unit. That is, it can be located in one place, or can be distributed on a plurality of network units. A part or all modules therein can be selected to achieve the purpose of the solutions of the embodiments of the present disclosure according to the practical requirements. Those of ordinary skill in the art can understand and practice the embodiments without an inventive effort.

Through the above descriptions of the embodiments, those skilled in the art may clearly understand that each implementation may be realized with the help with necessary universal hardware platform, and certainly, may be realized in the combination of hardware and software. Based on such understanding, the essential part of the technical solution or the part of the technical solution providing the technical contribution to the known art may be embodied in the form of a computer program product. In the present disclosure, the form of a computer program product implemented by one or more computer-usable storage media (including but not limited to a disk memory, CD-ROM, an optical memory, etc.) storing computer-usable program codes may be adopted.

The embodiments may further be described using the following clauses:

1. A data processing method, comprising:
determining a target function corresponding to a parameter optimization request in response to the parameter optimization request;
in a process of performing a parameter test on any candidate parameter by the target function, obtaining a determination result of the candidate parameter determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain a test result of the candidate parameter.

2. The data processing method of clause 1, wherein in the process of performing the parameter test on any candidate parameter by the target function, obtaining the determination result determining whether the parameter test meets the reduction condition comprises:

in the process of performing the parameter test on any candidate parameter by the target function, calling a target reduction algorithm in a plurality of test reduction algorithms to determine whether the parameter test meets the reduction condition to obtain the determination result.

3. The data processing method of clause 2, wherein the target reduction algorithm is determined from the plurality of test reduction algorithms by:

searching the target reduction algorithm matched with the parameter test from the plurality of test reduction algorithms.

4. The data processing method of clause 3, wherein searching the target reduction algorithm matched with the parameter test from the plurality of test reduction algorithms comprises:
determining first test information corresponding to the parameter test of the candidate parameter;
obtaining second test information respectively associated with the plurality of test reduction algorithms;
searching target test information matched with the first test information from the second test information respectively corresponding to the plurality of test reduction algorithms; and
determining the test reduction algorithm corresponding to the target test information as the target reduction algorithm.

5. The data processing method of clause 4, wherein the first test information comprises: a parameter test type, and wherein searching the target test information matched with the first test information from the second test information respectively corresponding to the plurality of test reduction algorithms comprises:

searching the target test information matched with the parameter test type of the first test information from the second test information respectively corresponding to the plurality of test reduction algorithms.

6. The data processing method of clause 5, wherein the parameter test type comprises: a serial test type and a parallel test type, and wherein searching the target test information matched with the parameter test type of the first test information from the second test information respectively corresponding to the plurality of test reduction algorithms comprises:
in response to the parameter test type of the candidate parameter being the serial test type, determining the target test information with the serial test type in the second test information respectively corresponding to the plurality of test reduction algorithms; or
in response to the parameter test type of the candidate parameter being the parallel test type, determining the target test information with the parallel test type in the second test information respectively corresponding to the plurality of test reduction algorithms.

7. The data processing method of any of clauses 4-6, wherein the first test information comprises: a parameter test stage, and wherein searching the target test information matched with the first test information from the second test information respectively corresponding to the plurality of test reduction algorithms comprises:

searching the target test information matched with the parameter test stage of the first test information from the second test information respectively corresponding to the plurality of test reduction algorithms.

8. The data processing method of any of clauses 4-7, wherein the first test information comprises: a parameter test stage and a parameter test type, and wherein searching the target test information matched with the first test information from the second test information respectively corresponding to the plurality of test reduction algorithms comprises:

determining the target test information matched with both the parameter test type and the parameter test stage from the second test information respectively corresponding to the plurality of test reduction algorithms.

9. The data processing method of any of clauses 2-8, wherein the plurality of test reduction algorithms comprise a self-defined reduction algorithm set by a target user; and
the target reduction algorithm is further determined from the plurality of test reduction algorithms by:
in response to the self-defined reduction algorithm set by the target user existing in the plurality of test reduction algorithms, determining the self-defined reduction algorithm as the target reduction algorithm.

10. The data processing method of clause 9, further comprising:

based on the self-defined reduction algorithm set by the target user, storing the self-defined reduction algorithm.

11. The data processing method of clause 9 or 10, wherein in response to the self-defined reduction algorithm set by the target user existing in the plurality of test reduction algorithms, determining the self-defined reduction algorithm as the target reduction algorithm comprises:
in response to the self-defined reduction algorithm set by the target user existing in the plurality of test reduction algorithms, generating prompt information showing existence of the self-defined reduction algorithm;
showing the prompt information to the target user for the target user to confirm whether the self-defined reduction algorithm is applicable to the parameter test; and
in response to the target user executing a confirming operation for the self-defined reduction algorithm applicable to the parameter test, determining the self-defined reduction algorithm as the target reduction algorithm.

12. The data processing method of any of clauses 1-11, wherein in the process of performing the parameter test on any candidate parameter by the target function, obtaining the determination result determining whether the parameter test meets the reduction condition comprises:

in the process of performing the parameter test on any candidate parameter by the target function, determining whether an intermediate test result of the parameter test meets the reduction condition to obtain the determination result.

13. The data processing method of clause 12, wherein the process of performing the parameter test on any candidate parameter by the target function, obtaining the determination result determining whether the intermediate test result of the parameter test meets the reduction condition comprises:

in the process of performing the parameter test on any candidate parameter by the target function, calling a target reduction algorithm in a plurality of test reduction algorithms to determine whether the intermediate test result of the parameter test meets the reduction condition to obtain the determination result.

14. The data processing method of clause 13, wherein the target reduction algorithm comprises a historical estimation algorithm, and the historical estimation algorithm determines whether the intermediate test result meets the reduction condition by:
according to historical intermediate results and historical test results respectively corresponding to a plurality of historical parameters, estimating an estimated test result corresponding to the intermediate test result;
determining whether the estimated test result is matched with a result threshold;
in response to a determination that the estimated test result is not matched with the result threshold, determining that the intermediate test result meets the reduction condition; or
in response to a determination that the estimated test result is matched with the result threshold, determining that the intermediate test result fails to meet the reduction condition.

15. The data processing method of clause 13 or 14, wherein the target reduction algorithm comprises: a computational comparison algorithm, and the computational comparison algorithm determines whether the intermediate test result meets the reduction condition by:
determining an intermediate reference value corresponding to a monitoring node for obtaining the intermediate test result in the parameter test process;
determining whether the intermediate reference value meets a preset reference threshold;
in response to a determination that the intermediate reference value fails to meet the preset reference threshold, determining that the intermediate test result meets the reduction condition; or
in response to a determination that the intermediate reference value meets the preset reference threshold, determining that the intermediate test result fails to meet the reduction condition.

16. The data processing method of any of clauses 1-15, further comprising:
determining at least one candidate parameter failing to meet the reduction condition in a plurality of candidate parameters, and obtaining the test result corresponding to the at least one candidate parameter; and
according to the test result corresponding to the at least one candidate parameter, selecting a target parameter meeting an optimal parameter condition from the at least one candidate parameter.

17. The data processing method of clause 16, further comprising:
receiving the parameter optimization request initiated for a to-be-processed parameter of a target resource;
wherein determining the target function corresponding to the parameter optimization request in response to the parameter optimization request comprises:
   determining the target function corresponding to a processing target of the target resource in response to the parameter optimization request; and
   the data processing method further comprising:
      performing sampling processing on the to-be-processed parameter for a plurality of times to obtain a plurality of candidate parameters; and
      after the operation of according to the test result corresponding to the at least one candidate parameter, selecting the target parameter meeting the optimal parameter condition from the at least one candidate parameter, the data processing method further comprising:
      according to a value of the to-be-processed parameter at the target parameter, generating processing information of the target resource to process the target resource according to the processing information.

18. The data processing method of clause 16 or 17, further comprising:
detecting a browsing operation initiated by a target user, and generating the parameter optimization request for a browsing parameter of the target user; and
wherein determining the target function corresponding to the parameter optimization request in response to the parameter optimization request comprises:
   determining the target function corresponding to a visit target of the target user in response to the parameter optimization request;
   the data processing method further comprising:
      performing sampling processing on the browsing parameter for a plurality of times to obtain a plurality of candidate parameters; and
      after the operation of according to the test result respectively corresponding to the at least one candidate parameter, selecting the target parameter meeting the optimal parameter condition from the at least one candidate parameter, the data processing method further comprising:
         according to a value of the browsing parameter at the target parameter, generating visit recommendation information of the target user; and
         searching a target product matched with the visit recommendation information from a product database so as to output the target product to the target user.

19. A data processing method, comprising:
determining a processing resource corresponding to a parameter processing interface in response to a request of calling the parameter processing interface;
executing using the processing resource corresponding to the parameter processing interface:
determining a target function corresponding to a parameter optimization request in response to the parameter optimization request;
in a process of performing a parameter test on any candidate parameter by the target function, obtaining a determination result determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain the test result of the candidate parameter.

20. A data processing method, comprising:
receiving a determination request for determining whether a parameter test on a candidate parameter by a target function meets a reduction condition initiated by a computing device, wherein the target function is determined by the computing device in response to a parameter optimization request; and
determining whether the parameter test meets the reduction condition in response to the determination request,
wherein the parameter test of the candidate parameter is stopped when the reduction condition is met, and the parameter test of the candidate parameter continues to be executed when the reduction condition fails to be met so as to obtain a test result of the candidate parameter.

21. A data processing device, comprising:
a first response module, configured to determine a target function corresponding to a parameter optimization request in response to the parameter optimization request;
a result obtaining module, configured to call a test reduction module in a process of performing a parameter test on any candidate parameter by the target function to determine whether the parameter test meets a reduction condition to obtain a determination result;
a first processing module, configured to stop the parameter test of the candidate parameter when the determination result is that the parameter test meets the reduction condition; and
a second processing module, configured to continue to execute the parameter test of the candidate parameter to obtain the test result of the candidate parameter when the determination result is that the parameter test fails to meet the reduction condition.

22. A data processing device, comprising:
a request receiving module, configured to receive a determination request for determining whether a parameter test on any candidate parameter by a target function meets a reduction condition initiated by a computing device, wherein the target function is determined by the computing device in response to a parameter optimization request; and
a second response module, configured to determine whether the parameter test meets the reduction condition in response to the determination request,
wherein the parameter test of the candidate parameter is stopped when the reduction condition is met, and the parameter test of the candidate parameter continues to be executed when the reduction condition fails to be met so as to obtain a test result of the candidate parameter.

23. A computing device, comprising:
a storage assembly configured to store one or more computer instructions; and
a processing assembly, wherein the one or more computer instructions are called by the processing assembly to execute operations comprising:
determining a target function corresponding to a parameter optimization request in response to the parameter optimization request;
in a process of performing a parameter test on any candidate parameter by the target function, obtaining a determination result of the candidate parameter determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain a test result of the candidate parameter.

24. A test reduction device, comprising:
a storage assembly configured to store one or more computer instructions; and
a processing assembly, wherein the one or more computer instructions are called by the processing assembly to execute operations comprising:
receiving a determination request for determining whether a parameter test on a candidate parameter by a target function meets a reduction condition initiated by a computing device, wherein the target function is in response to a parameter optimization request; and
determining whether the parameter test meets the reduction condition in response to the determination request,
wherein the parameter test of the candidate parameter is stopped when the reduction condition is met, and the parameter test of the candidate parameter continues to be executed when the reduction condition fails to be met so as to obtain a test result of the candidate parameter.

25. A computing device, comprising:
a memory configured to store one or more computer instructions; and
one or more processors configured to run the one or more computer instructions stored in the memory, to execute operations comprising:
   determining a target function corresponding to a parameter optimization request in response to the parameter optimization request;
   in a process of performing a parameter test on any candidate parameter by the target function, obtaining a determination result of the candidate parameter determining whether the parameter test meets a reduction condition;
   in response to the determination result being that the parameter test meets the reduction condition, stopping the parameter test of the candidate parameter; or
   in response to the determination result being that the parameter test fails to meet the reduction condition, continuing to execute the parameter test of the candidate parameter to obtain a test result of the candidate parameter.

26. The computing device of clause 25, wherein in the process of performing the parameter test on any candidate parameter by the target function, obtaining the determination result determining whether the parameter test meets the reduction condition comprises:

in the process of performing the parameter test on any candidate parameter by the target function, calling a target reduction algorithm in a plurality of test reduction algorithms to determine whether the parameter test meets the reduction condition to obtain the determination result.

27. The computing device of clause 26, wherein the target reduction algorithm is determined from the plurality of test reduction algorithms by:

searching the target reduction algorithm matched with the parameter test from the plurality of test reduction algorithms.

28. The computing device of clause 27, wherein searching the target reduction algorithm matched with the parameter test from the plurality of test reduction algorithms comprises:
determining first test information corresponding to the parameter test of the candidate parameter;
obtaining second test information respectively associated with the plurality of test reduction algorithms;
searching target test information matched with the first test information from the second test information respectively corresponding to the plurality of test reduction algorithms; and
determining the test reduction algorithm corresponding to the target test information as the target reduction algorithm.

29. The computing device of clause 28, wherein the first test information comprises: a parameter test type, and wherein searching the target test information matched with the first test information from the second test information respectively corresponding to the plurality of test reduction algorithms comprises:

searching the target test information matched with the parameter test type of the first test information from the second test information respectively corresponding to the plurality of test reduction algorithms.

30. The computing device of clause 29, wherein the parameter test type comprises: a serial test type and a parallel test type, and wherein searching the target test information matched with the parameter test type of the first test information from the second test information respectively corresponding to the plurality of test reduction algorithms comprises:
in response to the parameter test type of the candidate parameter being the serial test type, determining the target test information with the serial test type in the second test information respectively corresponding to the plurality of test reduction algorithms; or
in response to the parameter test type of the candidate parameter being the parallel test type, determining the target test information with the parallel test type in the second test information respectively corresponding to the plurality of test reduction algorithms.

31. The computing device of any of clauses 28-30, wherein the first test information comprises: a parameter test stage, and wherein searching the target test information matched with the first test information from the second test information respectively corresponding to the plurality of test reduction algorithms comprises:

searching the target test information matched with the parameter test stage of the first test information from the second test information respectively corresponding to the plurality of test reduction algorithms.

32. The computing device of any of clauses 28-31, wherein the first test information comprises: a parameter test stage and a parameter test type, and wherein searching the target test information matched with the first test information from the second test information respectively corresponding to the plurality of test reduction algorithms comprises:

determining the target test information matched with both the parameter test type and the parameter test stage from the second test information respectively corresponding to the plurality of test reduction algorithms.

33. The computing device of any of clauses 26-32, wherein the plurality of test reduction algorithms comprise a self-defined reduction algorithm set by a target user; and
the target reduction algorithm is further determined from the plurality of test reduction algorithms by:
in response to the self-defined reduction algorithm set by the target user existing in the plurality of test reduction algorithms, determining the self-defined reduction algorithm as the target reduction algorithm.

34. The computing device of clause 33, wherein the operations further comprise:

based on the self-defined reduction algorithm set by the target user, storing the self-defined reduction algorithm.

35. The computing device of clause 33 or 34, wherein in response to the self-defined reduction algorithm set by the target user existing in the plurality of test reduction algorithms, determining the self-defined reduction algorithm as the target reduction algorithm comprises:
in response to the self-defined reduction algorithm set by the target user existing in the plurality of test reduction algorithms, generating prompt information showing existence of the self-defined reduction algorithm;
showing the prompt information to the target user for the target user to confirm whether the self-defined reduction algorithm is applicable to the parameter test; and
in response to the target user executing a confirming operation for the self-defined reduction algorithm applicable to the parameter test, determining the self-defined reduction algorithm as the target reduction algorithm.

36. The computing device of any of clauses 25-35, wherein in the process of performing the parameter test on any candidate parameter by the target function, obtaining the determination result determining whether the parameter test meets the reduction condition comprises:

in the process of performing the parameter test on any candidate parameter by the target function, determining whether an intermediate test result of the parameter test meets the reduction condition to obtain the determination result.

37. The computing device of clause 36, wherein the process of performing the parameter test on any candidate parameter by the target function, obtaining the determination result determining whether the intermediate test result of the parameter test meets the reduction condition comprises:

in the process of performing the parameter test on any candidate parameter by the target function, calling a target reduction algorithm in a plurality of test reduction algorithms to determine whether the intermediate test result of the parameter test meets the reduction condition to obtain the determination result.

38. The computing device of clause 37, wherein the target reduction algorithm comprises a historical estimation algorithm, and the historical estimation algorithm determines whether the intermediate test result meets the reduction condition by:
according to historical intermediate results and historical test results respectively corresponding to a plurality of historical parameters, estimating an estimated test result corresponding to the intermediate test result;
determining whether the estimated test result is matched with a result threshold;
in response to a determination that the estimated test result is not matched with the result threshold, determining that the intermediate test result meets the reduction condition; or
in response to a determination that the estimated test result is matched with the result threshold, determining that the intermediate test result fails to meet the reduction condition.

39. The computing device of clause 37 or 38, wherein the target reduction algorithm comprises: a computational comparison algorithm, and the computational comparison algorithm determines whether the intermediate test result meets the reduction condition by:
determining an intermediate reference value corresponding to a monitoring node for obtaining the intermediate test result in the parameter test process;
determining whether the intermediate reference value meets a preset reference threshold;
in response to a determination that the intermediate reference value fails to meet the preset reference threshold, determining that the intermediate test result meets the reduction condition; or
in response to a determination that the intermediate reference value meets the preset reference threshold, determining that the intermediate test result fails to meet the reduction condition.

40. The computing device of any of clauses 25-39, wherein the operations further comprise:
determining at least one candidate parameter failing to meet the reduction condition in a plurality of candidate parameters, and obtaining the test result corresponding to the at least one candidate parameter; and
according to the test result corresponding to the at least one candidate parameter, selecting a target parameter meeting an optimal parameter condition from the at least one candidate parameter.

41. The computing device of clause 40, wherein the operations further comprise:
receiving the parameter optimization request initiated for a to-be-processed parameter of a target resource;
wherein determining the target function corresponding to the parameter optimization request in response to the parameter optimization request comprises:
determining the target function corresponding to a processing target of the target resource in response to the parameter optimization request; and
the data processing method further comprising:
   performing sampling processing on the to-be-processed parameter for a plurality of times to obtain a plurality of candidate parameters; and
   after the operation of according to the test result corresponding to the at least one candidate parameter, selecting the target parameter meeting the optimal parameter condition from the at least one candidate parameter, the data processing method further comprising:
   according to a value of the to-be-processed parameter at the target parameter, generating processing information of the target resource to process the target resource according to the processing information.

42. The computing device of clause 40 or 41, wherein the operations further comprise:
detecting a browsing operation initiated by a target user, and generating the parameter optimization request for a browsing parameter of the target user; and
wherein determining the target function corresponding to the parameter optimization request in response to the parameter optimization request comprises:
determining the target function corresponding to a visit target of the target user in response to the parameter optimization request;
the data processing method further comprising:
   performing sampling processing on the browsing parameter for a plurality of times to obtain a plurality of candidate parameters; and
   after the operation of according to the test result respectively corresponding to the at least one candidate parameter, selecting the target parameter meeting the optimal parameter condition from the at least one candidate parameter, the data processing method further comprising:
      according to a value of the browsing parameter at the target parameter, generating visit recommendation information of the target user; and
      searching a target product matched with the visit recommendation information from a product database so as to output the target product to the target user.

43. A computing device, comprising:
a memory configured to store one or more computer instructions; and
one or more processors configured to run the one or more computer instructions stored in the memory, to execute operations comprising:
   determining a processing resource corresponding to a parameter processing interface in response to a request of calling the parameter processing interface;
   executing using the processing resource corresponding to the parameter processing interface:
   determining a target function corresponding to a parameter optimization request in response to the parameter optimization request;
   in a process of performing a parameter test on any candidate parameter by the target function, obtaining a determination result determining whether the parameter test meets a reduction condition;
   in response to the determination result being that the parameter test meets the reduction condition, stopping the parameter test of the candidate parameter; or
   in response to the determination result being that the parameter test fails to meet the reduction condition, continuing to execute the parameter test of the candidate parameter to obtain the test result of the candidate parameter.

44. A computing device, comprising:
a memory configured to store one or more computer instructions; and
one or more processors configured to run the one or more computer instructions stored in the memory, to execute operations comprising:
   receiving a determination request for determining whether a parameter test on a candidate parameter by a target function meets a reduction condition initiated by a computing device, wherein the target function is determined by the computing device in response to a parameter optimization request; and
   determining whether the parameter test meets the reduction condition in response to the determination request,
   wherein the parameter test of the candidate parameter is stopped when the reduction condition is met, and the parameter test of the candidate parameter continues to be executed when the reduction condition fails to be met so as to obtain a test result of the candidate parameter.

45. A non-transitory computer-readable storage medium storing a set of computer instructions that are executable by one or more processors of a device to cause the device to perform operations comprising:
determining a target function corresponding to a parameter optimization request in response to the parameter optimization request;
in a process of performing a parameter test on any candidate parameter by the target function, obtaining a determination result of the candidate parameter determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain a test result of the candidate parameter.

46. The non-transitory computer-readable storage medium of clause 45, wherein in the process of performing the parameter test on any candidate parameter by the target function, obtaining the determination result determining whether the parameter test meets the reduction condition comprises:

in the process of performing the parameter test on any candidate parameter by the target function, calling a target reduction algorithm in a plurality of test reduction algorithms to determine whether the parameter test meets the reduction condition to obtain the determination result.

47. The non-transitory computer-readable storage medium of clause 46, wherein the target reduction algorithm is determined from the plurality of test reduction algorithms by:

searching the target reduction algorithm matched with the parameter test from the plurality of test reduction algorithms.

48. The non-transitory computer-readable storage medium of clause 47, wherein searching the target reduction algorithm matched with the parameter test from the plurality of test reduction algorithms comprises:
determining first test information corresponding to the parameter test of the candidate parameter;
obtaining second test information respectively associated with the plurality of test reduction algorithms;
searching target test information matched with the first test information from the second test information respectively corresponding to the plurality of test reduction algorithms; and
determining the test reduction algorithm corresponding to the target test information as the target reduction algorithm.

49. The non-transitory computer-readable storage medium of clause 48, wherein the first test information comprises: a parameter test type, and wherein searching the target test information matched with the first test information from the second test information respectively corresponding to the plurality of test reduction algorithms comprises:

searching the target test information matched with the parameter test type of the first test information from the second test information respectively corresponding to the plurality of test reduction algorithms.

50. The non-transitory computer-readable storage medium of clause 49, wherein the parameter test type comprises: a serial test type and a parallel test type, and wherein searching the target test information matched with the parameter test type of the first test information from the second test information respectively corresponding to the plurality of test reduction algorithms comprises:

in response to the parameter test type of the candidate parameter being the serial test type, determining the target test information with the serial test type in the second test information respectively corresponding to the plurality of test reduction algorithms; or

in response to the parameter test type of the candidate parameter being the parallel test type, determining the target test information with the parallel test type in the second test information respectively corresponding to the plurality of test reduction algorithms.

51. The non-transitory computer-readable storage medium of any of clauses 48-50, wherein the first test information comprises: a parameter test stage, and wherein searching the target test information matched with the first test information from the second test information respectively corresponding to the plurality of test reduction algorithms comprises:

searching the target test information matched with the parameter test stage of the first test information from the second test information respectively corresponding to the plurality of test reduction algorithms.

52. The non-transitory computer-readable storage medium of any of clauses 48-51, wherein the first test information comprises: a parameter test stage and a parameter test type, and wherein searching the target test information matched with the first test information from the second test information respectively corresponding to the plurality of test reduction algorithms comprises:

determining the target test information matched with both the parameter test type and the parameter test stage from the second test information respectively corresponding to the plurality of test reduction algorithms.

53. The non-transitory computer-readable storage medium of any of clauses 46-52, wherein the plurality of test reduction algorithms comprise a self-defined reduction algorithm set by a target user; and
the target reduction algorithm is further determined from the plurality of test reduction algorithms by:
in response to the self-defined reduction algorithm set by the target user existing in the plurality of test reduction algorithms, determining the self-defined reduction algorithm as the target reduction algorithm.

54. The non-transitory computer-readable storage medium of clause 53, wherein the operations further comprise:

based on the self-defined reduction algorithm set by the target user, storing the self-defined reduction algorithm.

55. The non-transitory computer-readable storage medium of clause 53 or 54, wherein in response to the self-defined reduction algorithm set by the target user existing in the plurality of test reduction algorithms, determining the self-defined reduction algorithm as the target reduction algorithm comprises:
in response to the self-defined reduction algorithm set by the target user existing in the plurality of test reduction algorithms, generating prompt information showing existence of the self-defined reduction algorithm;
showing the prompt information to the target user for the target user to confirm whether the self-defined reduction algorithm is applicable to the parameter test; and
in response to the target user executing a confirming operation for the self-defined reduction algorithm applicable to the parameter test, determining the self-defined reduction algorithm as the target reduction algorithm.

56. The non-transitory computer-readable storage medium of any of clauses 45-55, wherein in the process of performing the parameter test on any candidate parameter by the target function, obtaining the determination result determining whether the parameter test meets the reduction condition comprises:

in the process of performing the parameter test on any candidate parameter by the target function, determining whether an intermediate test result of the parameter test meets the reduction condition to obtain the determination result.

57. The non-transitory computer-readable storage medium of clause 56, wherein the process of performing the parameter test on any candidate parameter by the target function, obtaining the determination result determining whether the intermediate test result of the parameter test meets the reduction condition comprises:

in the process of performing the parameter test on any candidate parameter by the target function, calling a target reduction algorithm in a plurality of test reduction algorithms to determine whether the intermediate test result of the parameter test meets the reduction condition to obtain the determination result.

58. The non-transitory computer-readable storage medium of clause 57, wherein the target reduction algorithm comprises a historical estimation algorithm, and the historical estimation algorithm determines whether the intermediate test result meets the reduction condition by:
according to historical intermediate results and historical test results respectively corresponding to a plurality of historical parameters, estimating an estimated test result corresponding to the intermediate test result;
determining whether the estimated test result is matched with a result threshold;
in response to a determination that the estimated test result is not matched with the result threshold, determining that the intermediate test result meets the reduction condition; or
in response to a determination that the estimated test result is matched with the result threshold, determining that the intermediate test result fails to meet the reduction condition.

59. The non-transitory computer-readable storage medium of clause 57 or 58, wherein the target reduction algorithm comprises: a computational comparison algorithm, and the computational comparison algorithm determines whether the intermediate test result meets the reduction condition by:
determining an intermediate reference value corresponding to a monitoring node for obtaining the intermediate test result in the parameter test process;
determining whether the intermediate reference value meets a preset reference threshold;
in response to a determination that the intermediate reference value fails to meet the preset reference threshold, determining that the intermediate test result meets the reduction condition; or
in response to a determination that the intermediate reference value meets the preset reference threshold, determining that the intermediate test result fails to meet the reduction condition.

60. The non-transitory computer-readable storage medium of any of clauses 45-59, wherein the operations further comprise:
determining at least one candidate parameter failing to meet the reduction condition in a plurality of candidate parameters, and obtaining the test result corresponding to the at least one candidate parameter; and
according to the test result corresponding to the at least one candidate parameter, selecting a target parameter meeting an optimal parameter condition from the at least one candidate parameter.

61. The non-transitory computer-readable storage medium of clause 60, wherein the operations further comprise:
receiving the parameter optimization request initiated for a to-be-processed parameter of a target resource;
wherein determining the target function corresponding to the parameter optimization request in response to the parameter optimization request comprises:
determining the target function corresponding to a processing target of the target resource in response to the parameter optimization request; and
the data processing method further comprising:
   performing sampling processing on the to-be-processed parameter for a plurality of times to obtain a plurality of candidate parameters; and
   after the operation of according to the test result corresponding to the at least one candidate parameter, selecting the target parameter meeting the optimal parameter condition from the at least one candidate parameter, the data processing method further comprising:
   according to a value of the to-be-processed parameter at the target parameter, generating processing information of the target resource to process the target resource according to the processing information.

62. The non-transitory computer-readable storage medium of clause 60 or 61, wherein the operations further comprise:
detecting a browsing operation initiated by a target user, and generating the parameter optimization request for a browsing parameter of the target user; and
wherein determining the target function corresponding to the parameter optimization request in response to the parameter optimization request comprises:
determining the target function corresponding to a visit target of the target user in response to the parameter optimization request;
the data processing method further comprising:
   performing sampling processing on the browsing parameter for a plurality of times to obtain a plurality of candidate parameters; and
   after the operation of according to the test result respectively corresponding to the at least one candidate parameter, selecting the target parameter meeting the optimal parameter condition from the at least one candidate parameter, the data processing method further comprising:
      according to a value of the browsing parameter at the target parameter, generating visit recommendation information of the target user; and
      searching a target product matched with the visit recommendation information from a product database so as to output the target product to the target user.

63. A non-transitory computer-readable storage medium storing a set of computer instructions that are executable by one or more processors of a device to cause the device to perform operations comprising:
determining a processing resource corresponding to a parameter processing interface in response to a request of calling the parameter processing interface;
executing using the processing resource corresponding to the parameter processing interface:
determining a target function corresponding to a parameter optimization request in response to the parameter optimization request;
in a process of performing a parameter test on any candidate parameter by the target function, obtaining a determination result determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain the test result of the candidate parameter.

64. A non-transitory computer-readable storage medium storing a set of computer instructions that are executable by one or more processors of a device to cause the device to perform operations comprising:
receiving a determination request for determining whether a parameter test on a candidate parameter by a target function meets a reduction condition initiated by a computing device, wherein the target function is determined by the computing device in response to a parameter optimization request; and
determining whether the parameter test meets the reduction condition in response to the determination request,
wherein the parameter test of the candidate parameter is stopped when the reduction condition is met, and the parameter test of the candidate parameter continues to be executed when the reduction condition fails to be met so as to obtain a test result of the candidate parameter.

Finally, it should be noted that the above embodiments are merely used to illustrate the technical solutions of the present disclosure, but are not intended to limit the present disclosure. Although the present disclosure has been described in detail with the reference to the foregoing embodiments, those of ordinary skill in the art should understand that the technical solutions of each of the above embodiments may be modified, or some or all of the technical features in the above embodiments may be equivalently replaced. These modifications or replacements do not depart from the spirit and scope of the technical solutions of the embodiments of the present disclosure.

What is claimed is:

1. A computing device, comprising:
a memory configured to store one or more computer instructions; and
one or more processors configured to run the one or more computer instructions stored in the memory, to execute operations comprising:
determining a target function corresponding to a parameter optimization request in response to the parameter optimization request;
in a process of performing a parameter test on any candidate parameter by the target function, obtaining a determination result of the candidate parameter determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain a test result of the candidate parameter.

2. The computing device of claim 1, wherein in the process of performing the parameter test on any candidate parameter by the target function, obtaining the determination result determining whether the parameter test meets the reduction condition comprises:
in the process of performing the parameter test on any candidate parameter by the target function, calling a target reduction algorithm in a plurality of test reduction algorithms to determine whether the parameter test meets the reduction condition to obtain the determination result.

3. The computing device of claim 2, wherein the target reduction algorithm is determined from the plurality of test reduction algorithms by:
searching the target reduction algorithm matched with the parameter test from the plurality of test reduction algorithms.

4. The computing device of claim 3, wherein searching the target reduction algorithm matched with the parameter test from the plurality of test reduction algorithms comprises:
determining first test information corresponding to the parameter test of the candidate parameter;
obtaining second test information respectively associated with the plurality of test reduction algorithms;
searching target test information matched with the first test information from the second test information respectively corresponding to the plurality of test reduction algorithms; and
determining the test reduction algorithm corresponding to the target test information as the target reduction algorithm.

5. The computing device of claim 4, wherein the first test information comprises: a parameter test type, and wherein searching the target test information matched with the first test information from the second test information respectively corresponding to the plurality of test reduction algorithms comprises:
searching the target test information matched with the parameter test type of the first test information from the second test information respectively corresponding to the plurality of test reduction algorithms.

6. The computing device of claim 5, wherein the parameter test type comprises: a serial test type and a parallel test type, and wherein searching the target test information matched with the parameter test type of the first test information from the second test information respectively corresponding to the plurality of test reduction algorithms comprises:
in response to the parameter test type of the candidate parameter being the serial test type, determining the target test information with the serial test type in the second test information respectively corresponding to the plurality of test reduction algorithms; or
in response to the parameter test type of the candidate parameter being the parallel test type, determining the target test information with the parallel test type in the second test information respectively corresponding to the plurality of test reduction algorithms.

7. The computing device of claim 4, wherein the first test information comprises: a parameter test stage, and wherein searching the target test information matched with the first test information from the second test information respectively corresponding to the plurality of test reduction algorithms comprises:
searching the target test information matched with the parameter test stage of the first test information from the second test information respectively corresponding to the plurality of test reduction algorithms.

8. The computing device of claim 4, wherein the first test information comprises: a parameter test stage and a parameter test type, and wherein searching the target test information matched with the first test information from the second test information respectively corresponding to the plurality of test reduction algorithms comprises:
determining the target test information matched with both the parameter test type and the parameter test stage from the second test information respectively corresponding to the plurality of test reduction algorithms.

9. The computing device of claim 2, wherein the plurality of test reduction algorithms comprise a self-defined reduction algorithm set by a target user; and
the target reduction algorithm is further determined from the plurality of test reduction algorithms by:
in response to the self-defined reduction algorithm set by the target user existing in the plurality of test reduction algorithms, determining the self-defined reduction algorithm as the target reduction algorithm.

10. The computing device of claim 9, wherein the operations further comprise:
based on the self-defined reduction algorithm set by the target user, storing the self-defined reduction algorithm.

11. The computing device of claim 9, wherein in response to the self-defined reduction algorithm set by the target user existing in the plurality of test reduction algorithms, determining the self-defined reduction algorithm as the target reduction algorithm comprises:
in response to the self-defined reduction algorithm set by the target user existing in the plurality of test reduction algorithms, generating prompt information showing existence of the self-defined reduction algorithm;
showing the prompt information to the target user for the target user to confirm whether the self-defined reduction algorithm is applicable to the parameter test; and
in response to the target user executing a confirming operation for the self-defined reduction algorithm applicable to the parameter test, determining the self-defined reduction algorithm as the target reduction algorithm.

12. The computing device of claim 1, wherein in the process of performing the parameter test on any candidate parameter by the target function, obtaining the determination result determining whether the parameter test meets the reduction condition comprises:
in the process of performing the parameter test on any candidate parameter by the target function, determining whether an intermediate test result of the parameter test meets the reduction condition to obtain the determination result.

13. The computing device of claim 12, wherein the process of performing the parameter test on any candidate parameter by the target function, obtaining the determination result determining whether the intermediate test result of the parameter test meets the reduction condition comprises:
in the process of performing the parameter test on any candidate parameter by the target function, calling a target reduction algorithm in a plurality of test reduction algorithms to determine whether the intermediate test result of the parameter test meets the reduction condition to obtain the determination result.

14. The computing device of claim 13, wherein the target reduction algorithm comprises a historical estimation algorithm, and the historical estimation algorithm determines whether the intermediate test result meets the reduction condition by:
according to historical intermediate results and historical test results respectively corresponding to a plurality of historical parameters, estimating an estimated test result corresponding to the intermediate test result;
determining whether the estimated test result is matched with a result threshold;
in response to a determination that the estimated test result is not matched with the result threshold, determining that the intermediate test result meets the reduction condition; or
in response to a determination that the estimated test result is matched with the result threshold, determining that the intermediate test result fails to meet the reduction condition.

15. The computing device of claim 13, wherein the target reduction algorithm comprises: a computational comparison algorithm, and the computational comparison algorithm determines whether the intermediate test result meets the reduction condition by:
determining an intermediate reference value corresponding to a monitoring node for obtaining the intermediate test result in the parameter test process;
determining whether the intermediate reference value meets a preset reference threshold;
in response to a determination that the intermediate reference value fails to meet the preset reference threshold, determining that the intermediate test result meets the reduction condition; or
in response to a determination that the intermediate reference value meets the preset reference threshold, determining that the intermediate test result fails to meet the reduction condition.

16. The computing device of claim 1, wherein the operations further comprise:
determining at least one candidate parameter failing to meet the reduction condition in a plurality of candidate parameters, and obtaining the test result corresponding to the at least one candidate parameter; and
according to the test result corresponding to the at least one candidate parameter, selecting a target parameter meeting an optimal parameter condition from the at least one candidate parameter.

17. The computing device of claim 16, wherein the operations further comprise:
receiving the parameter optimization request initiated for a to-be-processed parameter of a target resource;
wherein determining the target function corresponding to the parameter optimization request in response to the parameter optimization request comprises:
determining the target function corresponding to a processing target of the target resource in response to the parameter optimization request; and
the data processing method further comprising:
performing sampling processing on the to-be-processed parameter for a plurality of times to obtain a plurality of candidate parameters; and
after the operation of according to the test result corresponding to the at least one candidate parameter, selecting the target parameter meeting the optimal parameter condition from the at least one candidate parameter, the data processing method further comprising:
according to a value of the to-be-processed parameter at the target parameter, generating processing information of the target resource to process the target resource according to the processing information.

18. The computing device of claim 16, wherein the operations further comprise:
detecting a browsing operation initiated by a target user, and generating the parameter optimization request for a browsing parameter of the target user; and
wherein determining the target function corresponding to the parameter optimization request in response to the parameter optimization request comprises:
determining the target function corresponding to a visit target of the target user in response to the parameter optimization request;
the data processing method further comprising:
performing sampling processing on the browsing parameter for a plurality of times to obtain a plurality of candidate parameters; and
after the operation of according to the test result respectively corresponding to the at least one candidate parameter, selecting the target parameter meeting the optimal parameter condition from the at least one candidate parameter, the data processing method further comprising:
according to a value of the browsing parameter at the target parameter, generating visit recommendation information of the target user; and
searching a target product matched with the visit recommendation information from a product database so as to output the target product to the target user.

19. A computing device, comprising:
a memory configured to store one or more computer instructions; and
one or more processors configured to run the one or more computer instructions stored in the memory, to execute operations comprising:
determining a processing resource corresponding to a parameter processing interface in response to a request of calling the parameter processing interface;
executing using the processing resource corresponding to the parameter processing interface:
determining a target function corresponding to a parameter optimization request in response to the parameter optimization request;
in a process of performing a parameter test on any candidate parameter by the target function, obtaining a determination result determining whether the parameter test meets a reduction condition;
in response to the determination result being that the parameter test meets the reduction condition, stopping the parameter test of the candidate parameter; or
in response to the determination result being that the parameter test fails to meet the reduction condition, continuing to execute the parameter test of the candidate parameter to obtain the test result of the candidate parameter.

20. A computing device, comprising:
a memory configured to store one or more computer instructions; and
one or more processors configured to run the one or more computer instructions stored in the memory, to execute operations comprising:
receiving a determination request for determining whether a parameter test on a candidate parameter by a target function meets a reduction condition initiated by a computing device, wherein the target function is determined by the computing device in response to a parameter optimization request; and
determining whether the parameter test meets the reduction condition in response to the determination request,
wherein the parameter test of the candidate parameter is stopped when the reduction condition is met, and the parameter test of the candidate parameter continues to be executed when the reduction condition fails to be met so as to obtain a test result of the candidate parameter.
